(19) United States
(12) Patent Application Publication
(10) Pub. No.: US 2026/0360296 A1
(43) Pub. Date: Nov. 12, 2026

(54) DISPLAY DEVICE AND METHOD OF DRIVING THE SAME, AND ELECTRONIC DEVICE INCLUDING THE DISPLAY DEVICE

(71) Applicant: Samsung Display Co., Ltd., Yongin-Si (KR)

(72) Inventors: Gyeong Pil JANG, Yongin-si (KR); Se Byung CHAE, Yongin-si (KR); Tae Gon IM, Yongin-si (KR); Tae Young JIN, Yongin-si (KR)

(21) Appl. No.: 19/649,515

(22) Filed: Apr. 16, 2026

(30) Foreign Application Priority Data
May 7, 2025 (KR) 10-2025-0059357

(51) Int. Cl. G09G 3/20; G09G 3/3233

(52) U.S. Cl. CPC G09G 3/2092; G09G 3/3233; G09G 2300/0819; G09G 2300/0861; G09G 2310/0291; G09G 2330/021

(57) ABSTRACT

A display device includes a display panel including sub-pixels, a power generator including regulators configured to generate constant voltages and supply the constant voltages to the display panel, a power supply circuit supplying the power generator with a first driving current and a second driving current for driving the regulators, and a timing controller controlling the power generator to supply the first driving current to the regulators during a blank period within a frame period and supply the second driving current to the regulators during an active period within the frame period. The first driving current has voltage greater than the second driving current.

### CROSS-REFERENCE TO RELATED APPLICATION

The application claims priority under 35 U.S.C. § 119(a) to Korean patent application No. 10-2025-0059357 filed on May 7, 2025 in the Korean Intellectual Property Office, the entire disclosure of which is incorporated herein by reference.

### BACKGROUND

### 1. Technical Field

Embodiments of the present disclosure generally relate to a display device and a method of driving the same, and an electronic device including the display device.

### 2. Related Art

With the development of information technology, the importance of a display device, which serves as the medium between a user and information, is becoming increasingly important. In response to this, the use of display devices such as liquid crystal display devices, organic light emitting display devices, and the like is increasing.

Various studies have been conducted on how to reduce the power consumption of display devices.

The foregoing description is provided solely for the purpose of understanding the background of the technical ideas of the invention, and is not to be construed as prior art known to those skilled in the art.

### SUMMARY

Embodiments provide a display device capable of reducing power consumption, a method of driving the display device, and an electronic device including the display device.

According to an embodiment of the present disclosure, a display device includes a display panel including sub-pixels, a power generator including regulators configured to generate constant voltages and supply the constant voltages to the display panel, a power supply circuit supplying the power generator with a first driving current and a second driving current for driving the regulators, and a timing controller controlling the power generator to supply the first driving current to the regulators during a blank period within a frame period and supply the second driving current to the regulators during an active period within the frame period. The first driving current has a voltage greater than the second driving current.

The display device may include a data driver configured to supply data signal to the sub-pixels through data lines. Each of the sub-pixels may include a pixel circuit coupled to a corresponding data line. The data signal may be written to the pixel circuit of each of the sub-pixels during the active period, and at least one transistor in the pixel circuit of each of the sub-pixels may remain in a turn-off state during the blank period.

The timing controller may output a switch control signal to the power generator to control the supply of the first driving current during the blank period and the supply of the second driving current during the active period.

Each of the regulators may include a first driving circuit and a second driving circuit. The power generator may include a first switch electrically connecting or disconnecting the power supply circuit and the first driving circuit of each of the regulators and, and a second switch electrically connecting or disconnecting the power supply circuit and the second driving circuit of each of the regulators.

The first driving circuit may include a first transistor including a first electrode connected to the first switch, a gate electrode connected to a first input terminal, and a second electrode connected to an output terminal, and a second transistor including a first electrode connected to the second electrode of the first transistor, a gate electrode connected to a second input terminal, and a second electrode connected to a ground power source. The second driving circuit may include a third transistor including a first electrode connected to the second switch, a gate electrode connected to the first input terminal, and a second electrode connected to the output terminal, and a fourth transistor including a first electrode connected to the second electrode of the third transistor, a gate electrode connected to the second input terminal, and a second electrode connected to the ground power source. The first driving circuit and the second driving circuit may amplify a difference between voltages input to the first input terminal and the second input terminal, respectively, and may output an amplified voltage difference to the output terminal.

The timing controller may include a switch control section for controlling operations of the first switch and the second switch. The switch control section may turn on the first switch and turn off the second switch during the blank period, and may turn off the first switch and turn on the second switch during the active period.

The timing controller may include an amplifier receiving a data enable signal defining the active period and the blank period within the frame period, and amplifying the data enable signal, and a comparator receiving an amplified data enable signal from the amplifier and comparing the amplified data enable signal with a reference value. The comparator may turn off the first switch and turn on the second switch when the amplified data enable signal is greater than the reference value, and the comparator may turn on the first switch and turn off the second switch when the amplified data enable signal is less than the reference value.

The timing controller may include a counter counting a number of times a horizontal synchronization signal is received, and the counter may be reset upon receipt of a vertical synchronization signal. The counter may turn on the first switch and turn off the second switch until a predetermined number of horizontal synchronization signals are received after receiving the vertical synchronization signal, and the counter may turn off the first switch and turn on the second switch from after receiving the predetermined number of horizontal signals until the vertical synchronization signal is received again.

According to an embodiment of the present disclosure, an electronic device includes a host transmitting control signals, and a display device including a display panel on which sub-pixels are arranged. The display device further includes a power generator including regulators configured to generate constant voltages and supply the constant voltages to the display panel, a power supply circuit supplying the power generator with a first driving current and a second driving current for driving the regulators, and a timing controller controlling the power generator based on the control signals. The timing controller controls the power generator to supply the first driving current to the regulators during a blank period within a frame period and supply the second driving current to the regulators during an active period within the frame period. The first driving current has a voltage greater than the second driving current.

The display device may further include a data driver configured to supply data signal to the sub-pixels through data lines. Each of the sub-pixels may include a pixel circuit coupled to a corresponding data line. The data signal may be written to the pixel circuit of each of the sub-pixels during the active period, and at least one transistor in the pixel circuit of each of the sub-pixels may remain in a turn-off state during the blank period.

The timing controller may output a switch control signal to the power generator to control the supply of the first driving current during the blank period and the supply of the second driving current during the active period.

Each of the regulators may include a first driving circuit and a second driving circuit. The power generator may further include a first switch electrically connecting or disconnecting the first driving circuit and the power supply circuit of each of the regulators, and a second switch electrically connecting or disconnecting the second driving circuit and the power supply circuit of each of the regulators.

The first driving circuit may include a first transistor including a first electrode connected to the first switch, a gate electrode connected to a first input terminal, and a second electrode connected to an output terminal, and a second transistor including a first electrode connected to the second electrode of the first transistor, a gate electrode connected to a second input terminal, and a second electrode connected to a ground power source. The second driving circuit may include a third transistor including a first electrode connected to the second switch, a gate electrode connected to the first input terminal, and a second electrode connected to the output terminal, and a fourth transistor including a first electrode connected to the second electrode of the third transistor, a gate electrode connected to the second input terminal, and a second electrode connected to the ground power source. The first driving circuit and the second driving circuit may amplify a difference between voltages input to the first input terminal and the second input terminal, respectively, and may output an amplified voltage difference to the output terminal.

The timing controller may include a switch control section for controlling operations of the first switch and the second switch. The switch control section may turn on the first switch and turn off the second switch during the blank period, and may turn off the first switch and turn on the second switch during the active period.

The timing controller may include an amplifier receiving a data enable signal defining the active period and the blank period within the frame period, and amplifying the data enable signal, and a comparator receiving an amplified data enable signal from the amplifier and comparing the amplified data enable signal with a reference value. The comparator may turn off the first switch and turn on the second switch when the amplified data enable signal is greater than the reference value, and the comparator may turn on the first switch and turn off the second switch when the amplified data enable signal is less than the threshold value.

The timing controller may include a counter counting a number of times a horizontal synchronization signal is received, and the counter may be reset upon receipt of a vertical synchronization signal. The counter may turn on the first switch and turn off the second switch until a predetermined number of the horizontal synchronization signals are received after receiving the vertical synchronization signal, and the counter may turn off the first switch and turn on the second switch from after receiving the predetermined number of horizontal signals until the vertical synchronization signal is received again.

According to an embodiment of the present disclosure, a method of driving a display device including a display panel on which sub-pixels are arranged, a power generator including regulators configured to generate constant voltages and supply the constant voltages to the display panel, and a power supply circuit supplying the power generator with a first driving current and a second driving current for driving the regulators includes supplying the first driving current to the regulators by supplying a switch control signal to the power generator during the blank period, and supplying the second driving current to the regulators by supplying the switch control signal to the power generator during the active period. The first driving current has a voltage greater than the second driving current.

Each of the regulators may include a first driving circuit and a second driving circuit, and the power generator may further include a first switch electrically connecting or disconnecting the first driving circuit and the power supply circuit of each of the regulators and a second switch electrically connecting or disconnecting the second driving circuit and the power supply circuit of each of the regulators. The supplying the first driving current to the regulators may include turning on the first switch and turning off the second switch during the blank period, and the supplying the second driving current to the regulators may include turning off the first switch and turning on the second switch during the active period.

The first driving circuit may include a first transistor including a first electrode connected to the first switch, a gate electrode connected to a first input terminal, and a second electrode connected to an output terminal, and a second transistor including a first electrode connected to the second electrode of the first transistor, a gate electrode connected to a second input terminal, and a second electrode connected to a ground power source. The second driving circuit may include a third transistor including a first electrode connected to the second switch, a gate electrode connected to the first input terminal, and a second electrode connected to the output terminal, and a fourth transistor including a first electrode connected to the second electrode of the third transistor, a gate electrode connected to the second input terminal, and a second electrode connected to the ground power source. The first driving circuit and the second driving circuit may amplify a difference between voltages input to the first input terminal and the second input terminal, respectively, and may output an amplified voltage difference to the output terminal

### BRIEF DESCRIPTION OF THE DRAWINGS

The above and other aspects and features of embodiments according to the present disclosure will become more apparent by describing, in further detail, aspects of the embodiments of the inventive concept with reference to the accompanying drawings.

FIG. 1 is a system block diagram of a display device according to an embodiment of the present disclosure.

FIG. 2 is a schematic representation of a pixel of FIG. 1.

FIG. 3 is a schematic diagram illustrating an embodiment of a pixel of FIG. 2.

FIG. 4 illustrates an equivalent circuit of a sub-pixel of FIG. 3.

FIGS. 5A and 5B illustrate waveforms of gate signals input to a sub-pixel of FIG. 4.

FIG. 6 is a schematic diagram illustrating a power generator of FIG. 1.

FIG. 7 illustrates an embodiment of a timing controller and a power generator including switches and regulators.

FIG. 8 illustrates an embodiment of a timing controller and a power generator including switches and regulators.

FIG. 9 illustrates an embodiment of a timing controller and a power generator including switches and regulators.

FIG. 10 is an exemplary diagram illustrating vertical synchronization signals with various frequencies.

FIG. 11 is a diagram illustrating a vertical synchronization signals and data enable signal.

FIGS. 12A - 12C are diagrams illustrating the effects of embodiments of the present disclosure.

FIG. 13 is a flowchart illustrating a method of driving a display device of FIG. 1.

FIG. 14 is a diagram illustrating a driving operation in step S100 of FIG. 13.

FIG. 15 is a diagram illustrating a driving operation in step S200 of FIG. 13.

FIG. 16 is a block diagram of an electronic device according to an embodiment.

FIGS. 17 - 19 are schematic views of various embodiments of an electronic device.

### DETAILED DESCRIPTION

Hereinafter, embodiments of the present disclosure will be described in further detail with reference to the accompanying drawings. It is noted that in the following description, the parts necessary to understand the operation according to the present disclosure will be described, and descriptions of other parts that are not directly related to the inventive concept of the present disclosure may be omitted in order not to obscure the gist of the present disclosure. It should also be noted that the present disclosure is not limited to the embodiments described herein and can be implemented in other forms. The embodiments described herein are provided to explain the present disclosure in further detail so as to enable those skilled in the art to easily implement the technical feature of the present disclosure.

Throughout the specification, it will be understood that, when a portion is referred to as being “connected” to another portion, it may include not only a case in which the portion is “directly connected” to, but also a case in which the portion is “indirectly connected” to the other portion with one or more other portions interposed therebetween. Terms used herein are only for describing embodiments of the inventive concept and are not intended to limit the present disclosure. It will be understood that the terms “comprise,” “include,” “have,” or its variations such as “comprising,” “including” or “having”, when used in this specification, specify the presence of stated features, integers, steps, operations, elements, components and/or group thereof, but do not preclude the presence or addition of one or more other features, integers, steps, operations, elements, components, and/or groups thereof. “At least one of X, Y, and Z,” “at least one of X, Y, or Z,” and “at least one selected from the group consisting of X, Y, and Z” may be construed as X only, Y only, Z only, any combination of two or more of X, Y, and Z, such as, for instance, XYZ, XYY, YZ, and ZZ, or any variation thereof. The term “and/or” includes any and all combinations of one or more of the associated listed items.

Terms such as “first” and “second” may be used to describe various components, but these components are not limited by these terms. These terms are used to distinguish one component from another component. Therefore, a “first” component may refer to a second component within a range of the present disclosure without departing from the scope disclosed herein.

Spatially relative terms, such as “under,” “on,” and the like, may be used for descriptive purposes, thereby describing a spatial relationship between one element or feature and another element(s) or feature(s) as shown in the drawings. Spatially relative terms are intended to include other directions in use, in operation, and/or in manufacturing, in addition to the direction depicted in the drawings. For example, when a device shown in the drawing is turned upside down, elements depicted as being positioned “under” other elements or features are positioned in a direction “on” the other elements or features. Therefore, in an embodiment, the term “under” may include both directions of on and under. In addition, the device may face in other directions (for example, rotated 90 degrees or facing in other directions) and, thus, the spatially relative terms used herein are interpreted according to the description of the embodiments with reference to the drawings.

Various embodiments are described with reference to drawings which schematically illustrate exemplary embodiments. Accordingly, it will be expected that shapes may vary, for example, according to tolerances and/or manufacturing techniques. Therefore, the embodiments disclosed herein are not to be construed as being limited to the specific shapes illustrated in the drawings, and are to be interpreted as including, for example, changes in shapes that may occur as a result of manufacturing. As described above, the shapes shown in the drawings may not show actual shapes of various elements of a device, and the present embodiments are not limited thereto.

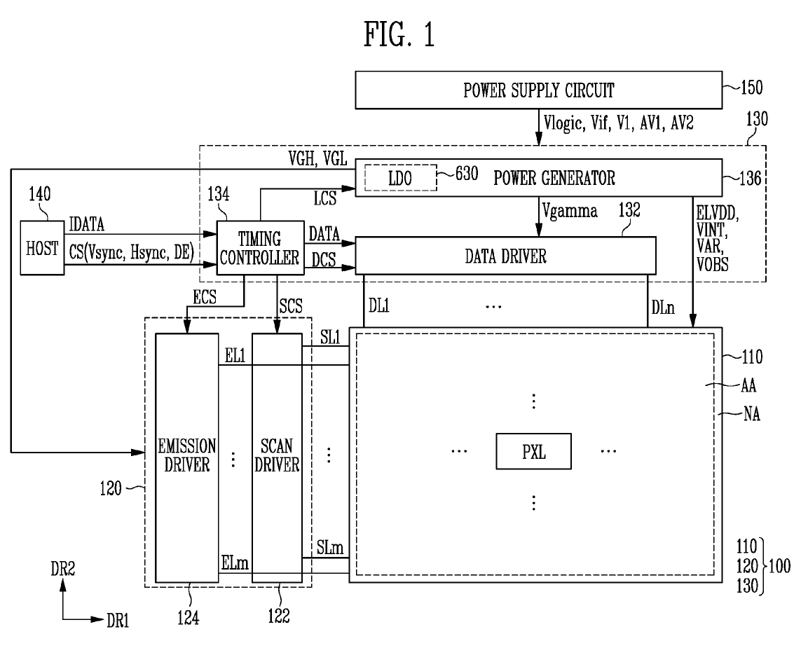

FIG. 1 is a system block diagram of a display device 100 according to an embodiment of the present disclosure.

Referring to FIG. 1, the display device 100 according to an embodiment of the present disclosure may include a display panel 110, a gate driving circuit 120, a panel driving circuit 130, and the like.

A plurality of pixels PXL are arranged on the display panel 110. The display panel 110 may include a plurality of data lines DL1, ..., DLn, where n is an integer greater than or equal to 2, a plurality of scan lines SL1, ..., SLm, where m is an integer greater than or equal to 2, a plurality of emission lines EL1, ..., ELm, which are electrically connected to the plurality of pixels PXL. One or more power supply voltage lines configured to apply a power supply voltage (e.g., a first power supply voltage ELVDD, a second power supply voltage VINT, a third power supply voltage VAR, a fourth power supply voltage VOBS, etc.) to the plurality of pixels PXL may be arranged on the display panel 110.

The display panel 110 may include a display area AA in which the plurality of pixels PXL are arranged, and a non-display area NA located in a peripheral area of the display area AA (e.g., an edge area of the display area AA).

The display panel 110 may have a flat (e.g., planar) shape, but the embodiment of the present disclosure is not limited thereto. For example, the display panel 110 may include curved portions (not shown) formed at the left and right ends. Curved surfaces of the curved portions may have a constant curvature or a varying curvature. In addition, the display panel 110 may have flexibility such as to be bent, curved, bendable, foldable, or rollable.

Each of the plurality of pixels PXL may include two or more sub-pixels. For example, the plurality of sub-pixels may be arranged in a matrix structure or a PENTILE^{TM} structure. However, the arrangement structure of the sub-pixels of the present disclosure is not limited to the structures as described above.

The plurality of scan lines SL1 to SLm may extend in a first direction DR1. The first direction DR1 may be, for example, a direction from left to right of the display panel 110. However, the extension direction of the scan lines SL1 to SLm of the present disclosure is not limited thereto.

The plurality of emission lines EL1 to ELm may extend in the first direction DR1. However, the extension direction of the emission lines EL1 to ELm of the present disclosure is not limited thereto.

The plurality of data lines DL1 to DLn may extend in a second direction DR2. The second direction DR2 may be different from the first direction DR1 (e.g., a direction intersecting the first direction DR1). For example, the second direction DR2 may be perpendicular to the first direction DR1. The second direction DR2 may be, for example, a direction from top to bottom of the display panel 110.

The gate driving circuit 120 may include a scan driver 122 and an emission driver 124. The gate driving circuit 120 is configured to output a gate signal having a high-level voltage VGH or a low-level voltage VGL (e.g., a scan signal, an emission signal, etc.) to a gate line (e.g., a scan line SL, an emission line EL, etc.) in response to an input control signal.

The scan driver 122 may output a scan signal (e.g., a scan signal having a turn-on level) to the plurality of scan lines SL1 to SLm in response to a scan driver control signal SCS. For example, the scan driver control signal SCS may include a start signal indicating the start of a frame, a horizontal synchronization signal Hsync for outputting a scan signal in accordance with the timing when a data voltage is applied to the plurality of pixels PXL.

The scan driver 122 may be implemented as an integrated circuit (e.g., a gate driver integrated circuit (GDIC)) formed separately from the display panel 110, or the scan driver 122 may be formed together with the display panel 110 and integrally positioned on at least a portion of the non-display area NA of the display panel 110. According to an embodiment, at least a portion of the scan driver 122 may overlap the display area AA.

The emission driver 124 may output an emission signal (e.g., an emission signal having a turn-on level) to the plurality of emission lines EL1 to ELm in response to an emission driver control signal ECS. For example, the emission driver control signal ECS may include a start signal, the horizontal synchronization signal Hsync for outputting an emission signal, and the like.

The emission driver 124 may be implemented as an integrated circuit formed separately from the display panel 110, or the emission driver 124 may be formed together with the display panel 110 and integrally positioned on at least a portion of the non-display area NA of the display panel 110. According to an embodiment, at least a portion of the emission driver 124 may overlap the display area AA.

The panel driving circuit 130 may include a data driver 132, a timing controller 134, and a power generator 136. The panel driving circuit 130 may be implemented as a single integrated circuit. According to an embodiment, the panel driving circuit 130 may be divided into two or more integrated circuits. For example, the data driver 132, the timing controller 134, and the power generator 136 may be functionally divided within one integrated circuit. For example, at least one of the data driver 132, the timing controller 134, and the power generator 136 may be implemented as a different integrated circuit from another circuit. For convenience of explanation, an embodiment in which the data driver 132, the timing controller 134, and the power generator 136 are implemented as the panel driving circuit 130 which is a single integrated circuit is described below. However, embodiments of the present disclosure are not limited thereto. The panel driving circuit 130 may be implemented, for example, as a timing controller embedded driver integrated circuit (TED-IC).

The data driver 132 may supply a data voltage to the plurality of data lines DL1 to DLn. The data driver 132 may generate the data voltage based on image data DATA, a data driver control signal DCS, and a gamma voltage Vgamma. The data driver 132 may output the generated data voltage to the plurality of data lines DL1 to DLn. The data driver control signal DCS may include, for example, a source start pulse SSP, a source shift clock SSC, a source output enable SOE signal, and the like.

The timing controller 134 may be configured to control the data driver 132, the gate driving circuit 120, and the power generator 136. The timing controller 134 may receive control signals CS (e.g., a vertical synchronization signal Vsync, the horizontal synchronization signal Hsync, a data enable signal DE, a clock signal, etc.) from an external source (e.g., a host 140). The vertical synchronization signal Vsync may define a length of one frame period. A frame period may include a plurality of horizontal periods. A horizontal period may refer to a time during which a data voltage is transferred to the pixels PXL arranged in the same pixel row. In addition, one frame period may refer to a time during which the data voltage is transferred to all of the plurality of pixels PXL on the display panel 110. The horizontal synchronization signal Hsync may define one horizontal period. The timing controller 134 may generate and output control signals DCS, SCS, ECS, and LCS for controlling the data driver 132, the gate driving circuit 120 including the scan driver 122 and the emission driver 124, and the power generator 136 based on the input control signals CS.

The timing controller 134 may receive input image data IDATA from an external source (e.g., the host 140) and may align the input image data IDATA in units of pixel rows. The timing controller 134 may convert the input image data IDATA to conform to a predetermined interface (e.g., low voltage differential signaling LVDS, a display port DP, an embedded display port eDP, etc.). The image data DATA output from the timing controller 134 to the data driver 132 may be converted inside the timing controller 134 to be compatible with the predetermined interface.

The timing controller 134 may receive the input image data IDATA, the control signals CS, and the like from an external source (e.g., the host 140) via an interface such as Serial Programming Interface (SPI), Inter Integrated Circuit (I2C), Mobile Industry Processor Interface (MIPI), and the like.

The timing controller 134 may be implemented as a logic circuit or a processor and may be disposed within the display device 100. The timing controller 134 may include one or more registers.

The timing controller 134 may receive power (e.g., an interface driving power Vif, a logic driving power Vlogic, etc.) from an external source (e.g., a power supply circuit 150). The timing controller 134 may use the input power to convert the input image data IDATA to be compatible with a predetermined interface, or to arrange the input image data IDATA in units of pixel rows.

The power generator 136 receives a voltage from the power supply circuit 150 and supply an appropriate level of voltage to each components of the display device 100. For example, the power generator 136 may include a resistor string for lowering voltage levels by distributing a driving power (or a driving current) (e.g., a first voltage V1) supplied from the power supply circuit 150.

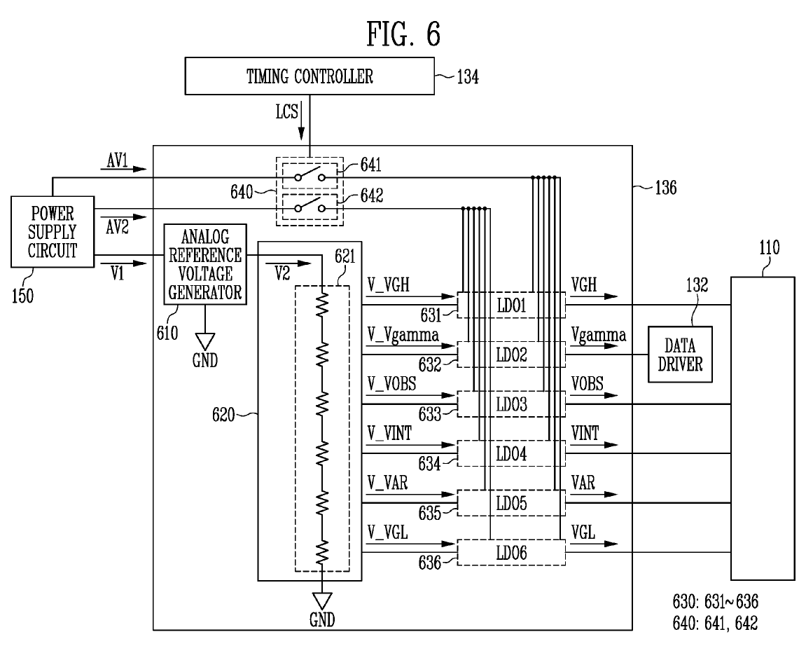

The power generator 136 may include regulators 630 (see FIG. 6) for maintaining a voltage level (e.g., the reduced voltage level) constant. The regulators 630 may be implemented as, for example, low-dropout (LDO) regulators. The regulators 630 may reduce (or eliminate) noise contained in the input power source to provide a power having a stable voltage level.

The power generator 136 may supply the display panel 110 with the first power supply voltage ELVDD, the second power supply voltage VINT, the third power supply voltage VAR, the fourth power supply voltage VOBS, and the like. The power generator 136 may supply the high-level voltage VGH, the low-level voltage VGL, and the like to the gate driving circuit 120. The power generator 136 may supply the gamma voltage Vgamma to the data driver 132.

The host 140 may execute software (e.g., a program, etc.) to control other components (e.g., the display device 100) connected to the host 140, and may perform various data processing or operations. The host 140 may include, for example, a set-top box, an application processor (AP), or the like.

The power supply circuit 150 may provide various power sources. The power supply circuit 150 may supply, for example, the logic driving power Vlogic, the interface driving power Vif, a first driving current AV1, a second driving current AV2, the first voltage V1, and the like. The power supply circuit 150 may supply the first power supply voltage ELVDD. However, according to an embodiment, the power generator 136 may generate and supply the first power supply voltage ELVDD to the display panel 110. The power supply circuit 150 may be implemented, for example, as a power management integrated circuit (PMIC).

The display device 100 according to an embodiment of the present disclosure may serve as a display screen not only for portable electronic devices such as a mobile phone, a smart phone, a tablet personal computer (PC), a smart watch, a watch phone, a mobile communication terminal, an electronic notebook, an e-book, a portable multimedia player (PMP), a navigation device, and an ultra-mobile personal computer (UMPC), but also for various products such as a television, a notebook computer, a monitor, signage, and the Internet of Things (IoT). The display device 100 according to an embodiment of the present disclosure may serve as a display screen for a virtual reality (VR) device, an augmented reality (AR) device, and the like.

When the display device 100 is used as a display screen for a virtual reality device, an augmented reality device, or the like, the display device 100 may be positioned very close to the eyes of a user. In addition, the display device 100 may have a high density of the pixels PXL when the display device 100 serves as the display screen for the virtual reality device, the augmented reality device, or the like. As one of the methods of increasing the density of the pixels PXL, the pixels PXL may be formed on a silicon substrate. A technique for forming a pixel circuit and a light emitting element (e.g., an organic light emitting diode (OLED)) connected thereto on the silicon substrate may be referred to as OLED on Silicon (OLEDoS).

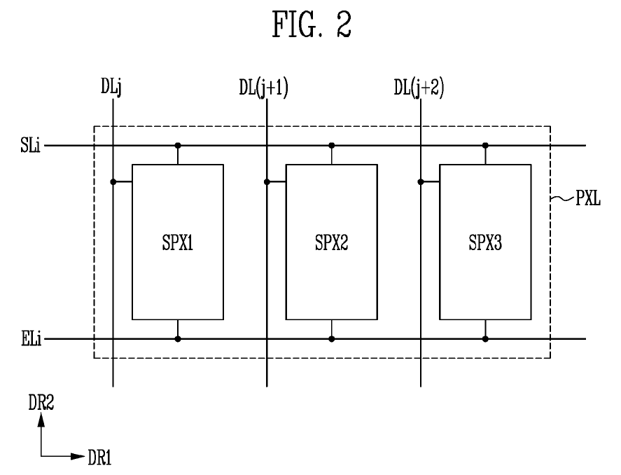

FIG. 2 is a schematic representation of the pixel PXL of FIG. 1.

The pixel PXL may include a plurality of sub-pixels (SPX1, SPX2, and SPX3) as shown in FIG. 2. Although FIG. 2 illustrates that the pixel PXL includes three sub-pixels, i.e., the first sub-pixel SPX1, the second sub-pixel SPX2, and the third sub-pixel SPX3, embodiments of the present disclosure are not limited thereto.

Each of the first sub-pixel SPX1, the second sub-pixel SPX2, and the third sub-pixel SPX3 may be electrically coupled to one of a plurality of data lines (DLj, DL(j+1), and DL(j+2)), where j is an integer from 1 to n-2. Each of the first sub-pixel SPX1, the second sub-pixel SPX2, and the third sub-pixel SPX3 may be electrically coupled to at least one scan line (SLi) of the plurality of scan lines, where i is an integer from 1 to m. Each of the first sub-pixel SPX1, the second sub-pixel SPX2, and the third sub-pixel SPX3 may be electrically connected to at least one emission line (Eli) of the plurality of emission lines. For example, referring to FIG. 2, the first sub-pixel SPX1 may be electrically coupled to the jth data line DLj, electrically coupled to the ith scan line SLi, and electrically coupled to the ith emission line ELi. The second sub-pixel SPX2 may be electrically connected to the (j+1)th data line DL(j+1), electrically connected to the ith scan line SLi, and electrically connected to the ith emission line ELi. The third sub-pixel SPX3 may be electrically connected to the (j+2)th data line DL(j+2), electrically connected to the ith scan line SLi, and electrically connected to the ith emission line ELi.

A sub-pixel SPX (e.g., the first sub-pixel SPX1, the second sub-pixel SPX2, or the third sub-pixel SPX3) or an emission area of the sub-pixel SPX may have a planar shape, such as a rectangle, a square, or a rhombus. For example, each of the first sub-pixel SPX1, the second sub-pixel SPX2, and the third sub-pixel SPX3 may have a rectangular planar shape with short sides in the first direction DR1 and long sides in the second direction DR2, as shown in FIG. 2. However, the embodiments of the present disclosure are not limited thereto, and the sub-pixel SPX or the emission area of the sub-pixel SPX may have a circular or polygonal shape.

At least two of the first sub-pixel SPX1, the second sub-pixel SPX2, and the third sub-pixel SPX3 may be arranged next to each other in the first direction DR1. For example, as shown in FIG. 2, the first sub-pixel SPX1, the second sub-pixel SPX2, and the third sub-pixel SPX3 may be arranged next to each other in the first direction DR1. For example, the first sub-pixel SPX1 and one of the second sub-pixel SPX2 and the third sub-pixel SPX3 may be arranged next to each other in the first direction DR1, and the other sub-pixel (e.g., the other sub-pixel among the second sub-pixel SPX2 and the third sub-pixel SPX3) and the first sub-pixel SPX1 may be arranged next to each other in the second direction DR2. For example, the second sub-pixel SPX2 and one of the first sub-pixel SPX1 and the third sub-pixel SPX3 may be arranged next to each other in the first direction DR1, and the other sub-pixel (e.g., the other sub-pixel among the first sub-pixel SPX1 and the third sub-pixel SPX3) and the second sub-pixel SPX2 may be arranged next to each other in the second direction DR2. However, embodiments of the present disclosure are not limited thereto examples.

The first sub-pixel SPX1 may emit light of a first wavelength band, the second sub-pixel SPX2 may emit light of a second wavelength band, and the third sub-pixel SPX3 may emit light of a third wavelength band. The light in the first wavelength band may be red light, the light in the second wavelength band may be green light, and the light in the third wavelength band may be blue light. The wavelength band of the red light may range from approximately 600 μm to 750 μm, the wavelength band of the green light may range from approximately 480 μm to 560 μm, and the wavelength band of the blue light may range from approximately 370 μm to 460 μm, but the colors of light emitted from the first sub-pixel SPX1, the second sub-pixel SPX2 and the third sub-pixel SPX3 are not limited to what is exemplified above.

Each of the first sub-pixel SPX1, the second sub-pixel SPX2, and the third sub-pixel SPX3 may include a light emitting element which emits light. For example, each of the first sub-pixel SPX1, the second sub-pixel SPX2, and the third sub-pixel SPX3 may include an organic light emitting diode (OLED) as a light emitting element, but embodiments of the present disclosure are not limited thereto.

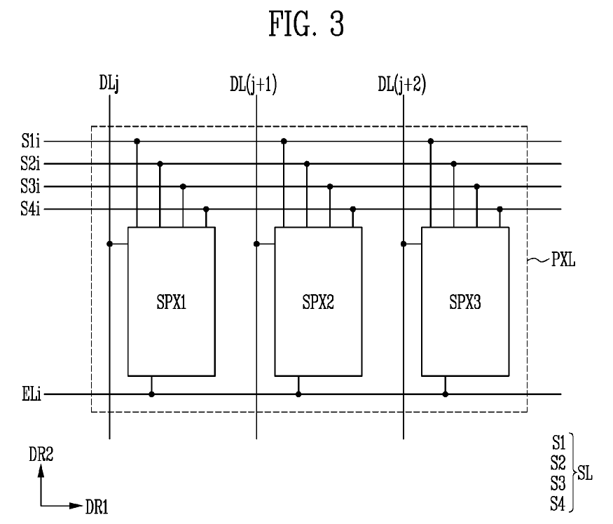

FIG. 3 is a schematic diagram illustrating an embodiment of the pixel PXL of FIG. 2.

Referring to FIG. 3, the pixel PXL according to an embodiment of the present disclosure may include the first sub-pixel SPX1, the second sub-pixel SPX2, and the third sub-pixel SPX3.

Each of the first sub-pixel SPX1, the second sub-pixel SPX2, and the third sub-pixel SPX3 may be electrically connected to an ith first scan line S1i (hereinafter, also referred to as a first scan line S1i), an ith second scan line S2i (hereinafter, also referred to as a second scan line S2i), an ith third scan line S3i (hereinafter, also referred to as a third scan line S3i), and an ith fourth scan line S4i (hereinafter, also referred to as a fourth scan line S4i).

Each of the first sub-pixel SPX1, the second sub-pixel SPX2, and the third sub-pixel SPX3 may be electrically connected to an ith emission line E1i (hereinafter, also referred to as an emission line E1i).

For example, referring to FIG. 3, the first sub-pixel SPX1 may be electrically connected to the jth data line DLj, the ith first to fourth scan signals S1i to S4i, and the ith emission line ELi. The second sub-pixel SPX2 may be electrically connected to the (j+1)th data line DL(j+1), the ith first to fourth scan signals S1i to S4i, and the ith emission line ELi. The third sub-pixel SPX3 may be electrically connected to the (j+2)th second data line DL(j+2), the ith first to fourth scan signals S1i to S4i, and the ith emission line ELi.

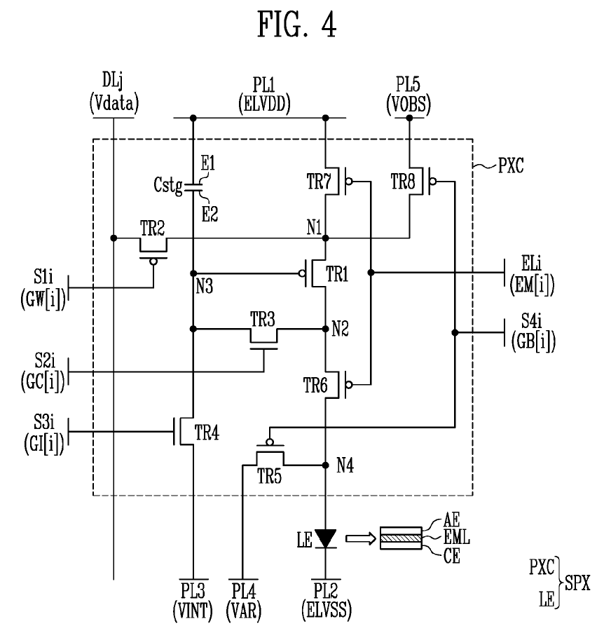

FIG. 4 is a diagram illustrating an equivalent circuit of the sub-pixel SPX of FIG. 3.

The sub-pixel SPX according to an embodiment of the present disclosure may include a pixel circuit PXC and a light emitting element LE. The pixel circuit PXC may include one or more switching elements (e.g., transistors) and one or more storage elements (e.g., capacitors).

The sub-pixel SPX as shown in FIG. 4 may be electrically connected to the jth data line DLj, the ith first to fourth scan signals S1i to S4i, and the ith emission line ELi. The sub-pixel SPX may correspond to the first sub-pixel SPX1 (see FIG. 3) as described above in FIG. 3. The description of the sub-pixel SPX in FIG. 4 may similarly apply to the second sub-pixel SPX2 and the third sub-pixel SPX3 described above in FIG. 3.

Referring to FIG. 4, the pixel circuit PXC according to an embodiment of the present disclosure may include first to eighth transistors TR1 to TR8 and a storage capacitor Cstg. However, embodiments of the present disclosure are not limited thereto.

The first transistor TR1 may be configured to generate a current (e.g., a driving current) flowing through the light emitting element LE. The first transistor TR1 may be connected between a first node N1 and a second node N2. A gate electrode of the first transistor TR1 may be electrically connected to a third node N3. One electrode (e.g., a source electrode) of the first transistor TR1 may be connected to the first node N1. The other electrode (e.g., a drain electrode) of the first transistor TR1 may be connected to the second node N2. The first transistor TR1 may be referred to as a driving transistor.

The second transistor TR2 may switch an electrical connection between the data line DLj and the first node N1 in response to a first scan signal GW[i]. The first scan signal GW[i] may be applied through the first scan line S1i. The second transistor TR2 may be turned on in response to the first scan signal GW[i] having a turn-on level, and a data voltage Vdata (or a voltage corresponding to the data voltage Vdata) may be applied to the first node N1. The second transistor TR2 may be referred to as a scan transistor.

The third transistor TR3 may be configured to switch an electrical connection between the second node N2 and the third node N3. The third transistor TR3 may be configured to switch the connection (e.g., the electrical connection) between the second node N2 and the third node N3 in response to a second scan signal GC[i]. The second scan signal GC[i] may be applied through the second scan line S2i. The third transistor TR3 may be electrically connected between the second node N2 and the third node N3 in response to the second scan signal GC[i] having the turn-on level. When the third transistor TR3 is turned on, the first transistor TR1 may be connected in a diode form. The third transistor TR3 may be referred to as a compensation transistor.

The fourth transistor TR4 may be configured to switch an electrical connection between the third node N3 and a third power line PL3. The fourth transistor TR4 may switch the electrical connection between the third node N3 and the third power line PL3 in response to a third scan signal GI[i]. The third scan signal GI[i] may be applied through the third scan line S3i. The second power supply voltage VINT may be applied through the third power line PL3. The fourth transistor TR4 may be electrically connected between the third node N3 and the third power line PL3 in response to the third scan signal GI[i] having the turn-on level. The second power supply voltage VINT may be referred to as a first initialization voltage VINT. The second power supply voltage VINT may have a turn-on level of the fourth transistor TR4. The fourth transistor TR4 may be referred to as a first initialization transistor.

The fifth transistor TR5 may be configured to switch an electrical connection between a fourth node N4 and a fourth power line PL4. The fifth transistor TR5 may be configured to switch the electrical connection between the fourth node N4 and the fourth power line PL4 in response to a fourth scan signal GB[i]. The fourth scan signal GB[i] may be applied through the fourth scan line S4i. The third power supply voltage VAR may be applied through the fourth power line PL4. The fifth transistor TR5 may be electrically connected between the fourth node N4 and the fourth power line PL4 in response to the fourth scan signal GB[i] having the turn-on level. The third power supply voltage VAR may be referred to as a second initialization voltage VAR or an anode reset voltage VAR. The fifth transistor TR5 may be referred to as a second initialization transistor.

The sixth transistor TR6 may be configured to switch an electrical connection between the second node N2 and the fourth node N4. The sixth transistor TR6 may switch the electrical connection between the second node N2 and the fourth node N4 in response to an emission signal EM[i]. The emission signal EM[i] may be applied through the emission line ELi. The sixth transistor TR6 may be electrically connected between the second node N2 and the fourth node N4 in response to the emission signal EM[i] having a turn-on level. The sixth transistor TR6 may be referred to as a first emission control transistor.

The seventh transistor TR7 may be configured to switch an electrical connection between a first power line PL1 and the first transistor TR1. The seventh transistor TR7 may switch the electrical connection between the first power line PL1 and the first transistor TR1 in response to the emission signal EM[i]. The first power supply voltage ELVDD may be applied through the first power line PL1. The seventh transistor TR7 may electrically connect the first power line PL1 to the first transistor TR1 in response to the emission signal EM[i] having the turn-on level. The seventh transistor TR7 may be referred to as a second emission control transistor.

The eighth transistor TR8 may be configured to switch an electrical connection between a fifth power line PL5 and the first node N1. The eighth transistor TR8 may switch the electrical connection between the fifth power line PL5 and the first node N1 in response to the fourth scan signal GB[i]. The fourth power supply voltage VOBS may be applied through the fifth power line PL5. The eighth transistor TR8 may electrically connect the fifth power line PL5 to the first node N1 in response to the fourth scan signal GB[i] having the turn-on level. The fourth power supply voltage VOBS may be referred to as an on-bias voltage VOBS. The eighth transistor TR8 may be referred to as a bias control transistor. The fourth power supply voltage VOBS may be applied to the first transistor TR1 so that a characteristic value of the first transistor TR1 may be kept constant. Accordingly, it may be desirable to control a voltage level of the fourth power supply voltage VOBS with greater precision.

The storage capacitor Cstg may be configured to maintain the voltage difference between the first power line PL1 and the third node N3. The storage capacitor Cstg may include one electrode (E1) electrically connected to the first power line PL1 and the other electrode (E2) electrically connected to the third node N3.

The light emitting element LE may include a first electrode AE, a second electrode CE, and a light emitting layer EML. The light emitting layer EML may be located between the first electrode AE and the second electrode CE, for example. The first electrode AE may be either an anode electrode or a cathode electrode. The second electrode CE may be the other one of the anode electrode and the cathode electrode. For convenience of explanation, it is assumed and described below that the first electrode AE is an anode electrode and the second electrode CE is a cathode electrode, but embodiments of the present disclosure are not limited thereto.

The light emitting element LE may include the first electrode AE electrically connected to the fourth node N4, and the second electrode CE electrically connected to a second power line PL2. A low potential power supply voltage ELVSS may be applied through the second power line PL2. A current (e.g., a driving current) with a magnitude corresponding to a voltage difference between the voltage applied to the fourth node N4 and the low potential power supply voltage ELVSS may flow through the light emitting element LE. The light emitting element LE may emit light with a brightness corresponding to a voltage difference between the voltage of the fourth node N4 and the low potential power supply voltage ELVSS. Accordingly, it may be desirable for the third power supply voltage VAR applied to the fourth node N4 to have a voltage level controlled with greater precision. For example, when a voltage level of the third power supply voltage VAR is outside a predetermined range, the light emitting element LE may unintentionally emit light, resulting in a deterioration of the display quality.

The light emitting layer EML may include an organic light emitting material of a polymer or low molecular weight compound. The light emitting layer EML may include an inorganic light emitting material, or quantum dots. For example, the light emitting layer EML may include an organic light emitting material including a polymer or low molecular weight compound and emit light in a predetermined wavelength band (e.g., a blue wavelength band, a green wavelength band, or a red wavelength band).

One or more transistors in the pixel circuit PXC may include a P-type semiconductor layer. For example, at least one of the first to eighth transistors TR1 to TR8 may be implemented as a field effect transistor (FET) including a P-channel metal oxide semiconductor (PMOS). For example, at least one of the first to eighth transistors TR1 to TR8 may be implemented as a field effect transistor including an N-type metal oxide semiconductor (NMOS).

Referring to FIG. 4, the first, second, and fifth to eighth transistors TR1, TR2, and TR5 to TR8 in the pixel circuit PXC are implemented as field-effect transistors constituting P-type metal-oxide semiconductors, and the third and fourth transistors TR3 and TR4 are implemented as field-effect transistors including N-type metal-oxide semiconductors. However, embodiments of the present disclosure are not limited thereto. For example, at least one of the first, second, fifth to eighth transistors TR1 and TR2, and TR5 to TR8 may be implemented as a field-effect transistor including an N-type metal-oxide semiconductor. For example, at least one of the third and fourth transistors TR3 and TR4 may be implemented as a field-effect transistor including a P-type metal-oxide semiconductor.

The transistors in the pixel driving circuit PXC may include amorphous silicon (a-Si) semiconductors, oxide semiconductors, low temperature polycrystalline silicon (LTPS) semiconductors, and the like. For example, some of the eight transistors in the pixel driving circuit PXC may include low temperature polysilicon semiconductors, while others may include oxide semiconductors.

For example, the third transistor TR3 and the fourth transistor TR4 may include an oxide semiconductor, while the remaining transistors TR1, TR2, and TR5 to TR8 may include a low-temperature polycrystalline silicon semiconductor. However, the present disclosure is not limited thereto. For example, at least one of the third transistor TR3 and the fourth transistor TR4 may include an amorphous silicon semiconductor or a low-temperature polycrystalline silicon semiconductor. For example, at least one of the remaining transistors TR1, TR2, and TR5 to TR8 may include an oxide semiconductor.

According to an embodiment, the first, second, third, and fourth scan signals GW[i], GC[i], GI[i], and GB[i] may be applied through different scan lines. For example, the first to fourth scan lines S1i to S4i may be different and distinct scan lines.

According to an embodiment, at least two of the first to fourth scan signals GW[i], GC[i], GI[i], and GB[i] may be applied through the same scan line. For example, at least two of the first to fourth scan lines S1i to S4i may be implemented as the same scan line.

According to an embodiment, one of the first to fourth scan signals GW[i], GC[i], GI[i], and GB[i] may be a signal differing from another only in phase. Thus, design and fabrication of the scan driver 122 (see FIG. 1) may be facilitated. However, embodiments of the present disclosure are not limited thereto.

The display panel 110 may display an image on a frame-period basis. An active period of the frame period may correspond to a period during which the display panel 110 displays an image, and a blank period of the frame period may correspond to a period during which the display panel 110 is prepared to display an image. During the active period, a data signal (or a data voltage) may be written to the pixel circuit PXC of each of the sub-pixels SPX, and during the blank period, at least one transistor in the pixel circuit PXC of each of the sub-pixels SPX may be maintained in a turn-off state.

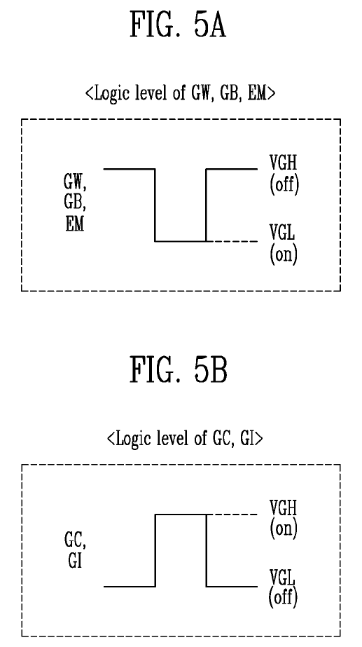

FIGS. 5A and 5B illustrate waveforms of gate signals GW, GC, GI, GB, and EM which are input to the sub-pixel SPX of FIG. 4.

The gate signals may include first, second, third, and fourth scan signals GW, GC, GI, and GB and an emission signal EM. In embodiments of the present disclosure, the gate signals may have a logic high level or a logic low level. In the following, a signal having a logic high level is described as having the high-level voltage VGH, and a signal having a logic low level is described as having the low-level voltage VGL. However, embodiments of the present disclosure are not limited thereto.

The high-level voltage VGH may be a turn-off level voltage of a pixel transistor including a p-type metal-oxide semiconductor. The high-level voltage VGH may be a turn-on level voltage of a pixel transistor including an N-type metal-oxide semiconductor.

The low-level voltage VGL may be a turn-on level voltage of a pixel transistor including a p-type metal-oxide semiconductor. The low-level voltage VGL may be a turn-off level voltage of a pixel transistor including an N-type metal-oxide semiconductor.

Referring to FIG. 5A, the high-level voltage VGH of the first scan signal GW, the fourth scan signal GB, and the emission signal EM may correspond to a turn-off level, and the low-level voltage VGL thereof may correspond to a turn-on level.

Referring to FIG. 5B, the high-level voltage VGH of the second scan signal GC and the third scan signal GI may correspond to a turn-on level, and the low-level voltage VGL thereof may correspond to a turn-off level.

FIG. 6 is a schematic diagram illustrating the power generator 136 of FIG. 1.

Referring to FIG. 6, the display device 100 may include the display panel 110, the data driver 132, the timing controller 134, the power generator 136, and the power supply circuit 150.

The power generator 136 may include an analog reference voltage generator 610, a voltage generation block 620, regulators 630, and switches 640.

The voltage generation block 620 may include a resistor string 621. The resistor string 621 may include a plurality of resistors connected in series. Referring to FIG. 6, the resistor string 621 may be connected between the analog reference voltage generator 610 and a ground power source GND. However, the ground power source GND may be replaced by a different power source.

The regulators 630 may include first to six regulators 631 to 636. However, embodiments of the present disclosure are not necessarily limited thereto. For example, the number of regulators 630 may be six or more. For example, the number of regulators 630 may be less than six. Hereinafter, it is assumed that the regulators 630 include six regulators 630 for convenience of description.

The switches 640 may include first and second switches 641 and 642.

The analog reference voltage generator 610 may be configured to receive the first voltage V1 from the power supply circuit 150, change (e.g. lower) a voltage level of the input voltage, and output a voltage of the changed voltage level (e.g., a second voltage V2) to the voltage generation block 620.

The voltage generation block 620 may be configured to output two or more voltages by using the second voltage V2. The voltage generation block 620 may include the resistor string 621, and the resistor string 621 may generate and output two or more voltages from the second voltage V2. For example, the voltage generation block 620 may output at least one of a first input voltage V_VGH, a second input voltage V_Vgamma, a third input voltage V_VOBS, a fourth input voltage V_VINT, a fifth input voltage V_VAR, and a sixth input voltage V_VGL. Referring further to FIG. 1, the first input voltage V_VGH may be a voltage for generating the high-level voltage VGH. The second input voltage V_Vgamma may be a voltage for generating the gamma voltage Vgamma. The third input voltage V_VOBS may be a voltage for generating the fourth power supply voltage VOBS. The fourth input voltage V_VINT may be a voltage for generating the second power supply voltage VINT. The fifth input voltage V_VAR may be a voltage for generating the third power supply voltage VAR. The sixth input voltage V_VGL may be a voltage for generating the low-level voltage VGL.

The voltage generation block 620 may output the first input voltage V_VGH to the first regulator 631. The voltage generation block 620 may output the second input voltage V_Vgamma to the second regulator 632. The voltage generation block 620 may output the third input voltage V_VOBS to the third regulator 633. The voltage generation block 620 may output the fourth input voltage V_VINT to the fourth regulator 634. The voltage generation block 620 may output the fifth input voltage V_VAR to the fifth regulator 635. The voltage generation block 620 may output the sixth input voltage V_VGL to the sixth regulator 636.

The first regulator 631 may generate the high-level voltage VGH based on the first input voltage V_VGH and output the high-level voltage VGH to the display panel 110. The second regulator 632 may generate the gamma voltage Vgamma based on the second input voltage V_Vgamma and output the gamma voltage Vgamma to the data driver 132. The second regulator 632 may have an additional configuration for generating the gamma voltage Vgamma.

The third regulator 633 may generate the fourth power supply voltage VOBS based on the third input voltage V_VOBS and may output the fourth power supply voltage VOBS to the display panel 110. The fourth regulator 634 may generate the second power supply voltage VINT based on the fourth input voltage V_VINT and may output the second power supply voltage VINT to the display panel 110. The fifth regulator 635 may generate the third power supply voltage VAR based on the fifth input voltage V_VAR and may output the third power supply voltage VAR to the display panel 110. The sixth regulator 636 may generate the low-level voltage VGL based on the sixth input voltage V_VGL and may output the low-level voltage VGL to the display panel 110.

The power supply circuit 150 may supply the first driving current AV1 and the second driving current AV2 to the power generator 136 (or the regulators 630) so as to drive the regulators 630. The power supply circuit 150 may supply the first driving current AV1 to the first to sixth regulators 631 to 636. The power supply circuit 150 may supply the second driving current AV2 to the first to sixth regulators 631 to 636. In embodiments of the present disclosure, the magnitude of the first driving current AV1 may be greater than that of the second driving current AV2.

The first switch 641 may electrically connect, or electrically disconnect the power supply circuit 150 and the regulators 630. The first switch 641 may electrically connect the power supply circuit 150 to the regulators 630 when the first switch 641 is turned on. In contrast, when the first switch 641 is turned off, the first switch 641 may electrically disconnect the power supply circuit 150 from the regulators 630.

The second switch 642 may electrically connect or disconnect the power supply circuit 150 and the regulators 630. The second switch 642 may electrically connect the power supply circuit 150 to the regulators 630 when the second switch 642 is turned on. In contrast, the second switch 642 may electrically disconnect the power supply circuit 150 from the regulators 630 when the second switch 642 is turned off.

The timing controller 134 may supply a switch control signal a to the power generator 136 (or to the switches 640). The operation of the switches 640 may be controlled by the switch control signal LCS.

The display panel 110 (see FIG. 1) may display an image on a frame-period basis, and may be arranged to display an image during an active period AP (FIG. 11) of a frame period and to prepare displaying the image during a blank period BP (FIG. 11) of the frame period. During the blank period BP, in response to the switch control signal LCS, the first switch 641 may be turned on and the second switch 642 may be turned off. The regulators 630 may receive the first driving current AV1.

In contrast, in the active period AP, in response to the switch control signal LCS, the first switch 641 may be turned off and the second switch 642 may be turned on. The regulators 630 may receive the second driving current AV2.

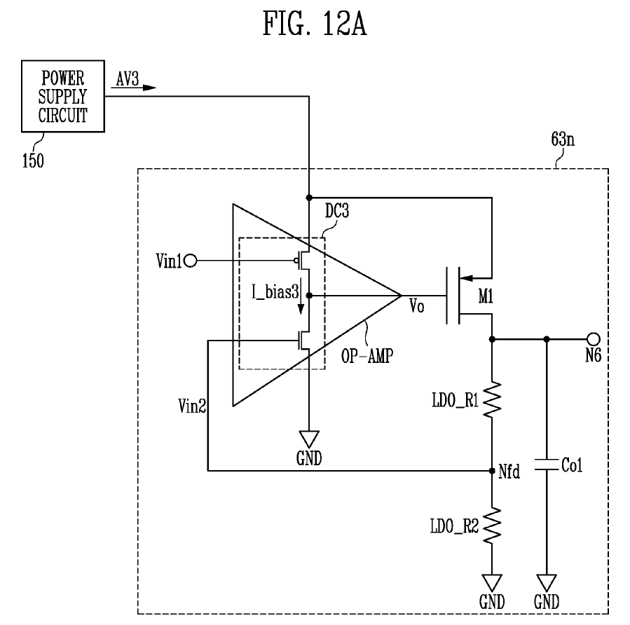

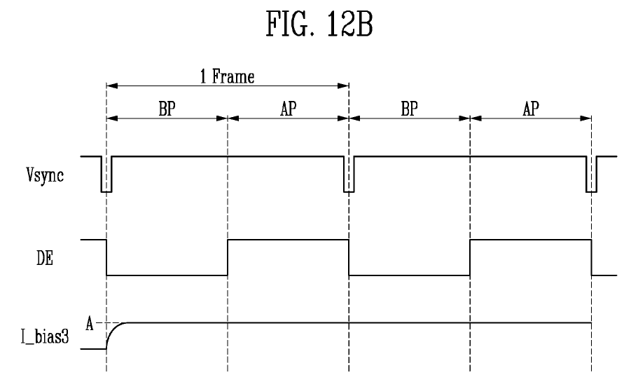

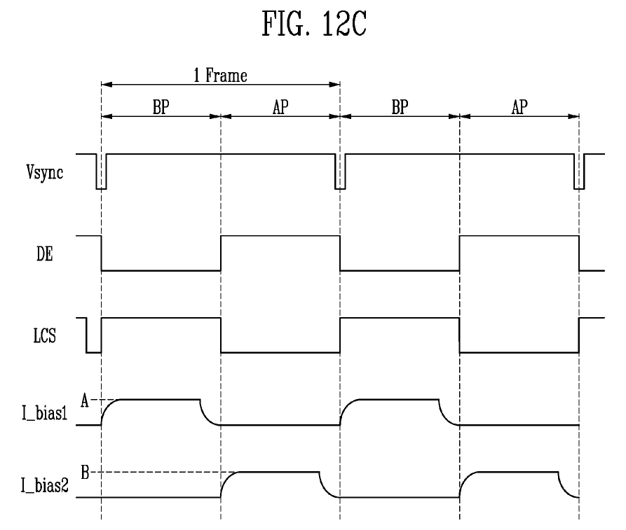

The effects of supplying the first driving current AV1 to the regulators 630 during the blank period and supplying the second driving current AV2 to the regulators 630 during the active period in the display device 100 according to embodiments of the present disclosure are described below with reference to FIGS. 12A - 12C.

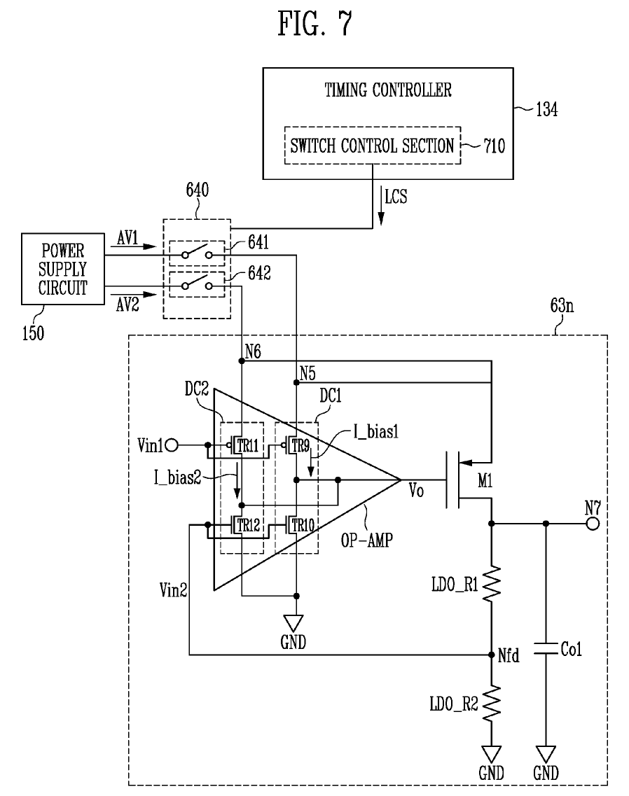

FIG. 7 is a diagram illustrating an embodiment of the power generator 136 including switches 641 and 642, and regulators 630. For ease of explanation, FIG. 7 illustrates only one of the regulators 630 (e.g., an nth regulator 63n, where n is a natural number from 1 to 6). The remaining regulators may be substantially the same as one of the regulators.

Referring to FIG. 7, the display device 100 may include the timing controller 134, the power supply circuit 150, the first switch 641, the second switch 642, and the nth regulator 63n.

Referring to FIG. 7, the nth regulator 63n may include an operational amplifier OP-AMP, a power transistor M1, a first feedback resistor LDO_R1, a second feedback resistor LDO_R2, and an output capacitor Co1.

The operational amplifier OP-AMP may include a first driving circuit DC1, a second driving circuit DC2, and the like.

The first driving circuit DC1 may include a ninth transistor TR9 and a tenth transistor TR10.

The ninth transistor TR9 may include a first electrode connected to the first switch 641, a gate electrode connected to a first input terminal Vin1, and a second electrode connected to an output terminal Vo. The tenth transistor TR10 may include a first electrode connected to the second electrode of the ninth transistor TR9, a gate electrode connected to a second input terminal Vin2, and a second electrode connected to the ground power source GND.

The second driving circuit DC2 may include an eleventh transistor TR11 and a twelfth transistor TR12.

The eleventh transistor TR11 may include a first electrode connected to the second switch 642, a gate electrode connected to the first input terminal Vin1, and a second electrode connected to the output terminal Vo. The twelfth transistor TR12 may include a first electrode connected to the second electrode of the eleventh transistor TR11, a gate electrode connected to the second input terminal Vin2, and a second electrode connected to the ground power source GND.

The first input terminal Vin1 may be coupled to the voltage generation block 620. For example, the first regulator 631 may receive the first input voltage V_VGH from the voltage generation block 620 via the first input terminal Vin1. The second regulator 632 may receive the second input voltage V_Vgamma from the voltage generation block 620 via the first input terminal Vin1. The third regulator 633 may receive the third input voltage V_VOBS from the voltage generation block 620 via the first input terminal Vin1. The fourth regulator 634 may receive the fourth input voltage V_VINT from the voltage generation block 620 via the first input terminal Vin1. The fifth regulator 635 may receive the fifth input voltage V_VAR from the voltage generation block 620 via the first input terminal Vin1. The sixth regulator 636 may receive the sixth input voltage V_VGL via the first input terminal Vin1 from the voltage generation block 620.

The second input terminal Vin2 may be connected to a feedback node Nfd. The voltages applied to the first input terminal Vin1 and the second input terminal Vin2 may generate a first bias current I_bias1 in the first driving circuit DC1. The voltages applied to the first input terminal Vin1 and the second input terminal Vin2 may generate a second bias current I_bias2 in the second driving circuit DC2. The first driving circuit DC1 may amplify the difference between the voltage applied to the first input terminal Vin1 and the voltage applied to the second input terminal Vin2 by a gain value (e.g., a predetermined gain value), and may output the amplified voltage to the output terminal Vo. Similarly, the second driving circuit DC2 may amplify a difference between the voltage input to the first input terminal Vin1 and the voltage input to the second input terminal Vin2 by a gain value (e.g., a predetermined gain value), and may output the amplified voltage to the output terminal Vo.

The power supply circuit 150 provides driving power for the operational amplifier OP-AMP (or the first driving circuit DC1) (or the second driving circuit DC2). For example, the first driving circuit DC1 may receive the first driving current AV1, and the first driving current AV1 may be used to drive the ninth and tenth transistors TR9 and TR10. For example, the second driving circuit DC2 may receive the second driving current AV2, and the second driving current AV2 may be used to drive the eleventh and twelfth transistors TR11 and TR12. During the blank period BP (see FIG. 11), only the first driving circuit DC1 is activated, and the first driving circuit DC1 may amplify the difference between the voltages input to the first input terminal Vin1 and the second input terminal Vin2, respectively, and may output the amplified voltage difference to the output terminal Vo. During the active period AP (see FIG. 11), only the second driving circuit DC2 is activated, and the second driving circuit DC2 may amplify the difference between the voltages input to the first input terminal Vin1 and the second input terminal Vin2, respectively, and may output the amplified voltage difference to the output terminal Vo.

During the blank period BP, where the voltage output from the nth regulator 63n varies, a bias current required to drive the transistors in the first driving circuit DC1 may be greater. On the other hand, during the active period AP, where the voltage output from the nth regulator 63n is constant, a bias current required for driving the transistors in the second driving circuit DC2 may be smaller. The transistors of the first driving circuit DC1 may require a greater bias current than the transistors of the second driving circuit DC2. The magnitude of the first driving current AV1 may be set to be greater than the second driving current AV2.

The power transistor M1 may be connected between a first driving terminal N5 and a constant voltage output terminal N7. Further, the power transistor M1 may be connected between a second driving terminal N6 and the constant voltage output terminal N7. Different magnitudes of current may flow through the power transistor M1, depending on the magnitude of the voltage output from the output terminal Vo. For example, as the magnitude of the voltage output from the output terminal Vo increases, more current may flow toward the constant voltage output terminal N7 (e.g., from the power transistor M1 to the constant voltage output terminal N7). For example, when the magnitude of the voltage output from the output terminal Vo decreases, less current may flow toward the constant voltage output terminal N7.

The output capacitor Co1 may include one electrode and the other electrode. One electrode of the output capacitor Co1 may be connected (e.g., electrically connected) to the constant voltage output terminal N7. The output capacitor Co1 is configured to maintain a constant magnitude of the voltage output from the constant voltage output terminal N7. The other electrode of the output capacitor Co1 may be connected (e.g., electrically connected) to the ground power source GND. For example, depending on the magnitude of the voltage output from the output terminal Vo, the magnitude of the current flowing toward the constant voltage output terminal N7 from the power transistor M1 may vary. However, the fluctuation of the voltage applied to the constant voltage output terminal N7 may be mitigated by the output capacitor Co1.

The first feedback resistor LDO_R1 and the second feedback resistor LDO_R2 are connected (e.g., electrically connected) at the feedback node Nfd. The first feedback resistor LDO_R1 may be connected between the constant voltage output terminal N7 and the feedback node Nfd. The second feedback resistor LDO_R2 may be connected between the feedback node Nfd and the ground power source GND.

A process of adjusting the voltage of the constant voltage output terminal N7 by the first feedback resistor LDO_R1 and the second feedback resistor LDO_R2 is as follows.

For example, when the voltage of the constant voltage output terminal N7 increases, the voltage of the feedback node Nfd increases. As the voltage of the feedback node Nfd increases, the voltage applied to the second input terminal Vin2 increases. Accordingly, the difference between the voltages applied to the first input terminal Vin1 and the second input terminal Vin2 decreases, and the voltage output from the output terminal Vo may become smaller. Accordingly, the amount of current flowing toward the constant voltage output terminal N6 from the power transistor M1 may be reduced, and the voltage of the constant voltage output terminal N7 may be lowered.

For example, when the voltage of the constant voltage output terminal N7 is lowered, the voltage of the feedback node Nfd decreases. When the voltage of the feedback node Nfd decreases, the voltage applied to the second input terminal Vin2 is reduced. Accordingly, the difference between the voltages applied to the first input terminal Vin1 and the second input terminal Vin2 may increase, and the voltage output from the output terminal Vo may be larger. Accordingly, the amount of current flowing toward the constant voltage output terminal N7 from the power transistor M1 may increase, and the voltage of the constant voltage output terminal N7 may increase.

As described above, a constant voltage of a fixed level may be output to the constant voltage output terminal N7. For example, the first regulator 631 may output the high-level voltage VGH via the constant voltage output terminal N7. The second regulator 632 may output the gamma voltage Vgamma via the constant voltage output terminal N7. The third regulator 633 may output the fourth power supply voltage VOBS via the constant voltage output terminal N7. The fourth regulator 634 may output the second power supply voltage VINT via the constant voltage output terminal N7. The fifth regulator 635 may output the third power supply voltage VAR via the constant voltage output terminal N7. The sixth regulator 636 may output the low-level voltage VGL via the constant voltage output terminal N7.

Referring to FIG. 7, an embodiment in which the first driving circuit DC1 and the second driving circuit DC2 are located inside the operational amplifier OP-AMP (e.g., DC1 and DC2 are included in the operational amplifier OP-AMP) is illustrated, but embodiments of the present disclosure are not limited thereto. For example, the first driving circuit DC1 and the second driving circuit DC2 may be located outside of the operational amplifier OP-AMP.

The timing controller 134 may include a switch control section 710.

The display panel 110 (see FIG. 1) may display an image on a frame-period basis. Within one frame period, the active period AP may correspond to a period during which the display panel 110 displays an image. Within one frame period, the blank period BP may correspond to a period during which the display panel 110 is prepared to display an image.

The timing controller 134 (or the switch control section 710) may supply the switch control signal LCS to the first switch 641 and the second switch 642 so as to control the operations of the first switch 641 and the second switch 642, respectively. For example, the switch control section 710 may turn on the first switch 641 and turn off the second switch 642 during the blank period BP such that the first driving current AV1 may be supplied to the first driving circuit DC1 and the second driving current AV2 may not be supplied to the second driving circuit DC2. As a result, during the blank period BP, the first driving circuit DC1 may be driven and the second driving circuit DC2 may not be driven. For example, the switch control section 710 may turn off the first switch 641 and turn on the second switch 642 during the active period AP such that the first driving current AV1 may not be supplied to the first driving circuit DC1, and the second driving current AV2 may be supplied to the second driving circuit DC2. As a result, during the active period AP, the first driving circuit DC1 may not be driven and the second driving circuit DC2 may be driven.

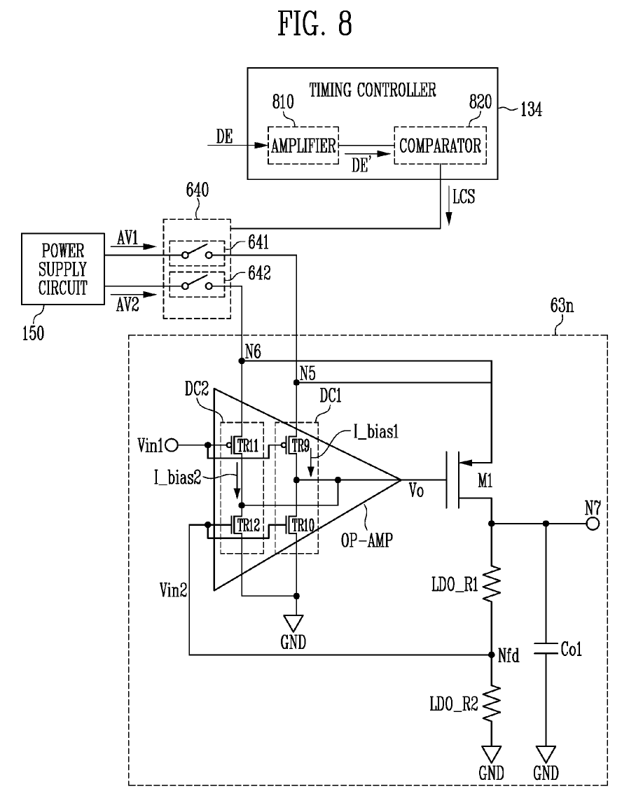

FIG. 8 illustrates an embodiment of a timing controller 134 and a power generator 136 including switches 641 and 642, and regulators 630. For convenience of explanation, FIG. 8 illustrates only one of the regulators 630 (e.g., the nth regulator 63n, where n is a natural number from 1 to 6). The remaining regulators may be substantially the same as one of the regulators.

Descriptions overlapping with those of the regulators 630 with reference to FIG. 7 will be omitted below.

The timing controller 134 may include an amplifier 810 and a comparator 820.

The display panel 110 (see FIG. 1) may display an image on a frame-period basis. The active period AP (see FIG. 11) may correspond to a period when the display panel 110 displays an image, and the blank period BP (see FIG. 11) may correspond to a period when the display panel 110 is prepared to display an image. A period when the data enable signal DE is at a logic high level may represent the active period AP, and a period when the data enable signal DE is at a logic low level may represent the blank period BP. In other words, the data enable signal DE may serve as a signal which defines each of the active period AP and the blank period BP.

The amplifier 810 may receive the data enable signal DE from an external source. The amplifier 810 may then amplify the received data enable signal DE and transfer the amplified data enable signal DE’ to the comparator 820.

The comparator 820 may receive the amplified data enable signal DE’ from the amplifier 810 and compare the amplified data enable signal DE’ with a reference value. Further, the comparator 820 may supply the switch control signal LCS to the first switch 641 and the second switch 642, respectively, based on the comparison result to control the operations of the first switch 641 and the second switch 642. For example, when the amplified data enable signal DE’ is less than a reference value, the comparator 820 may determine that period as the blank period BP. The comparator 820 may turn on the first switch 641 and turn off the second switch 642 during the blank period BP such that the first driving current AV1 may be supplied to the first driving circuit DC1 and the second driving current AV2 may not be supplied to the second driving circuit DC2. As a result, the first driving circuit DC1 may be driven and the second driving circuit DC2 may not be driven during the blank period BP. For example, when the amplified data enable signal DE’ is greater than the reference value, the comparator 820 may determine that period as the active period AP. The comparator 820 may turn off the first switch 641 and turn on the second switch 642 during the active period AP such that the first driving current AV1 may not be supplied to the first driving circuit DC1 and the second driving current AV2 may be supplied to the second driving circuit DC2. As a result, during the active period AP, the first driving circuit DC1 may not be driven and the second driving circuit DC2 may be driven.

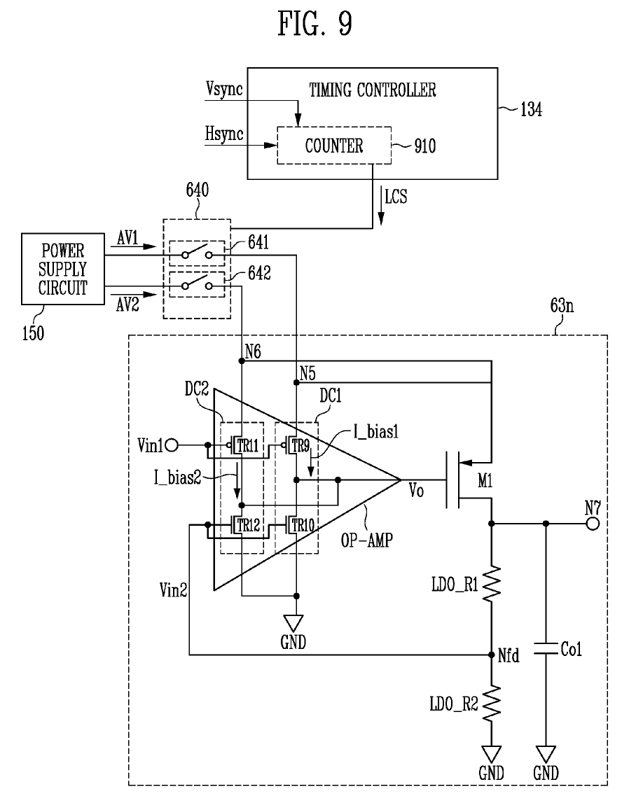

FIG. 9 illustrates an embodiment of a timing controller 134 and a power generator 136 including switches 641 and 642, and regulators 630. For convenience of explanation, FIG. 9 illustrates only one of the regulators 630 (e.g., the nth regulator 63n, where n is a natural number from 1 to 6). The remaining regulators may be substantially the same as one of the regulators.

Descriptions overlapping with those of the regulators 630 with reference to FIG. 7 will be omitted below.

The timing controller 134 may include a counter 910.

The display panel 110 (see FIG. 1) may display an image on a frame-period basis. Within one frame period, the active period AP (see FIG. 11) may correspond to a period during which the display panel 110 displays an image. Within one frame period, the blank period BP (see FIG. 11) may correspond to a period during which the display panel 110 does not display an image.

The counter 910 may receive the vertical synchronization signal Vsync and the horizontal synchronization signal Hsync from an external source.

The vertical synchronization signal Vsync may define a length of one frame period. One frame period may include a plurality of horizontal periods. A horizontal period may be a time during which a data voltage is transferred to the pixels PXL arranged in the same pixel row. In addition, one frame period may mean a time during which the data voltage is transferred to all of the plurality of pixels PXL on the display panel 110. The horizontal synchronization signal Hsync may define one horizontal period.

The counter 910 may count the number of times the horizontal synchronization signal Hsync is received and reset the count upon receiving the vertical synchronization signal Vsync. The counter 910, after receiving the vertical synchronization signal Vsync, may determine the period until a predetermined number of horizontal synchronization signals Hsync are received as the blank period BP. In addition, the counter 910 may determine the active period AP as the period from after receiving a predetermined number of horizontal synchronization signals Hsync until the vertical synchronization signal Vsync is received again.

The counter 910 may supply the switch control signal LCS to the first switch 641 and the second switch 642, respectively, to control the operations of the first switch 641 and the second switch 642. For example, the counter 910 may turn on the first switch 641 and turn off the second switch 642 during the blank period BP such that the first driving current AV1 may be supplied to the first driving circuit DC1 and the second driving current AV2 may not be supplied to the second driving circuit DC2. As a result, during the blank period BP, the first driving circuit DC1 may be driven and the second driving circuit DC2 may not be driven. For example, the counter 910 may turn off the first switch 641 and turn on the second switch 642 during the active period AP such that the first driving current AV1 may not be supplied to the first driving circuit DC1, and the second driving current AV2 may be supplied to the second driving circuit DC2. As a result, during the active period AP, the first driving circuit DC1 may not be driven and the second driving circuit DC2 may be driven.

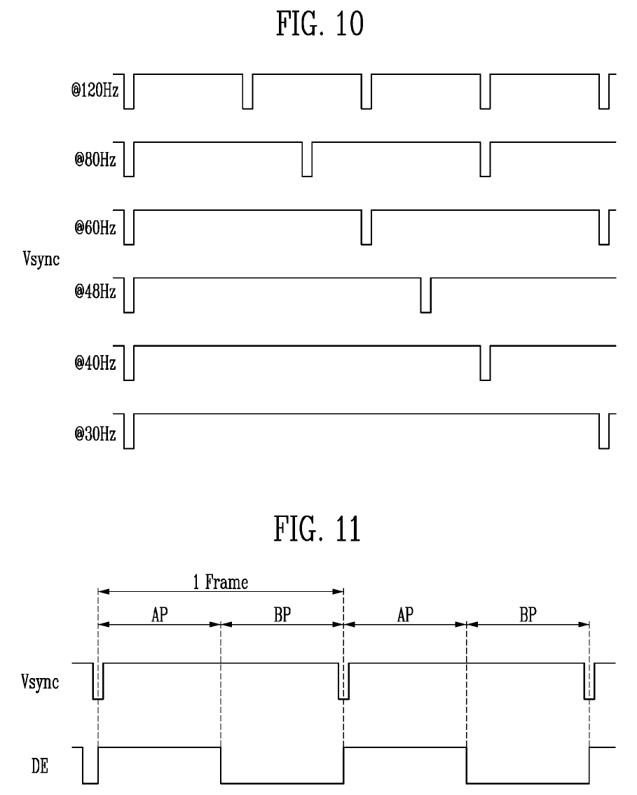

FIG. 10 is an exemplary diagram illustrating vertical synchronization signals with various frequencies.

Referring to FIG. 10, the vertical synchronization signal Vsync may have various frequencies. For example, the vertical synchronization signal Vsync may have a frequency of 120 Hz, 80 Hz, 60 Hz, 48 Hz, 40 Hz, 30 Hz, and the like. In addition, according to embodiments, the frequency may be 24 Hz, 20 Hz, 15 Hz, 12 Hz, 10 Hz, 8 Hz, 6 Hz, 5 Hz, 4 Hz, 3 Hz, 2 Hz, 1 Hz, and the like, and embodiments of the present disclosure are not limited thereto. For example, the frequency of the vertical synchronization signal Vsync may be greater than 120 Hz, or less than 1 Hz.

The frequency (or a driving frequency) of the vertical synchronization signal Vsync corresponds to the update (or refresh) rate of an image displayed on the display panel 110 (see FIG. 1). For example, as the frequency of the vertical synchronization signal Vsync increases, the update rate of the image displayed on the display panel 110 increases. Accordingly, the user may view a smoother image. For example, as the frequency of the vertical synchronization signal Vsync decreases, the update rate of the image displayed on the display panel 110 decreases. Accordingly, the power consumption of the display device 100 (see FIG. 1) may be lowered.

FIG. 11 is a diagram illustrating the vertical synchronization signal Vsync and the data enable signal DE.

The vertical synchronization signal Vsync may define a length of one frame period 1Frame, and the data enable signal DE may define a length of the active period AP and the blank period BP within the one frame period 1Frame. For example, the length of the period during which the vertical synchronization signal Vsync has a logic high level may correspond to the length of the one frame period 1Frame. For example, within the one frame period 1Frame, a period during which the data enable signal DE has a logic high level may correspond to the active period AP, and a period during which the data enable signal DE has a logic low level may correspond to the blank period BP.

FIGS. 12A - 12C are diagrams illustrating the effects of embodiments of the present disclosure. FIGS. 12A and 12B are diagrams illustrating that power consumption increases if the nth regulator 63n includes only one driving circuit (e.g., a third driving circuit DC3). FIG. 12C is a diagram illustrating the effect of reduced power consumption in the nth regulator 63n according to embodiments of the present disclosure.

Referring to FIG. 12A, the nth regulator 63n may include only one driving circuit (e.g., a third driving circuit DC3). The third driving circuit DC3 may amplify the difference between the voltages input to the first input terminal Vin1 and the second input terminal Vin2 and output the amplified voltage difference to the output terminal Vo.

In addition, to drive the third driving circuit DC3, the power supply circuit 150 may supply a third driving current AV3 to the third driving circuit DC3. A third bias current I_bias3 having a value ‘A’ may flow in transistors included in the third driving circuit DC3 which receives the third driving current AV3.

Referring to FIG. 12B, in order to continuously output a voltage of a constant level to the output terminal Vo from the operational amplifier OP-AMP, the third bias current I_bias3, caused by the voltage input to the first input terminal Vin1 and the voltage input to the second input terminal Vin2, may continuously flow in the operational amplifier OP-AMP (or through the transistors included in the third driving circuit DC3). Although a relatively small bias current is required during the active period AP compared to the blank period BP, a bias current of the same magnitude may flow during both the active period AP and the blank period BP. As a result, the power consumption of the nth regulator 63n may increase unnecessarily.

Therefore, a method of lowering the power consumption of the nth regulator 63n is required.

Referring to FIGS. 7, 8, 9, and 12C, one frame period 1Frame may include the active period AP and the blank period BP.

During the blank period BP, the switch control signal LCS may have a high level (or a logic high level). The first switch 641 may be in a turn-on state, the second switch 642 may be in a turn-off state, and the first bias current I_bias1 having the value ‘A’ may flow through the transistors included in the first driving circuit DC1. On the other hand, a second bias current I_bias2 may not flow through the transistors included in the second driving circuit DC2.

During the active period AP, the switch control signal LCS may have a low level (or a logic low level). The first switch 641 may be in a turn-off state, the second switch 642 may be in a turn-on state, and the second bias current I_bias2 having a value ‘B’ may flow through the transistors included in the second driving circuit DC2. Here, ‘B’ may be a value less than ‘A’.

The regulators 630 may drive circuits differently during the active period AP and the blank period BP. For example, the regulators 630 may drive the second driving circuit DC2 during the active period AP. In contrast, the regulators 630 may drive the first driving circuit DC1 during the blank period BP.

Furthermore, since the second driving circuit DC2 operating during the active period AP requires a relatively less bias current, the magnitude of the second driving current supplied thereto may be reduced. As a result, the display device 100 according to embodiments of the present disclosure may efficiently reduce power consumption due to the regulators 630.

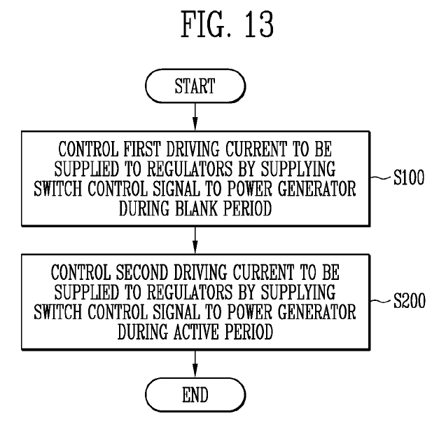

FIG. 13 is a flowchart illustrating a method of driving the display device 100 of FIG. 1.

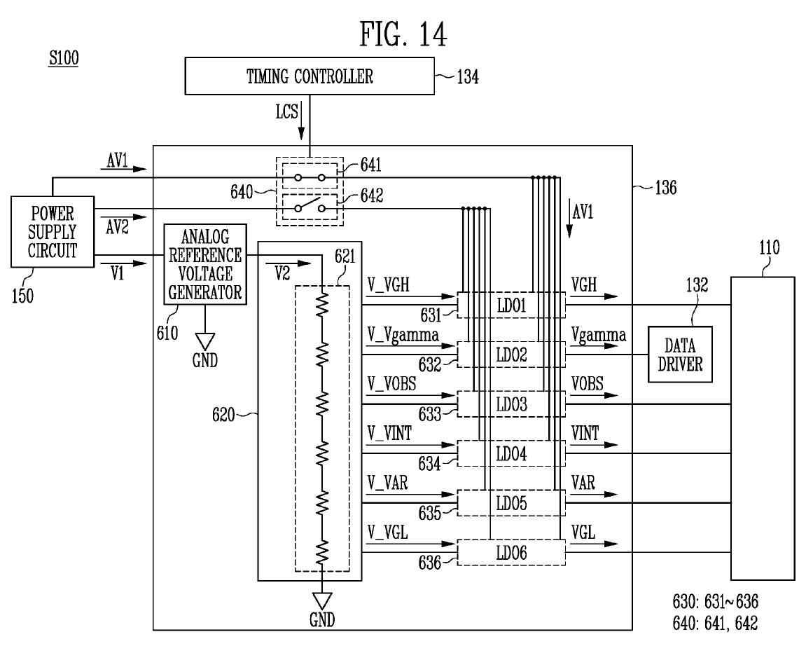

Referring to FIGS. 6, 11, and 13, in step S100, during the blank period BP, a process of controlling the first driving current AV1 to be supplied to the regulators 630 by supplying the switch control signal LCS to the power generator 136 may be performed. This process will be described below with reference to FIG. 14.

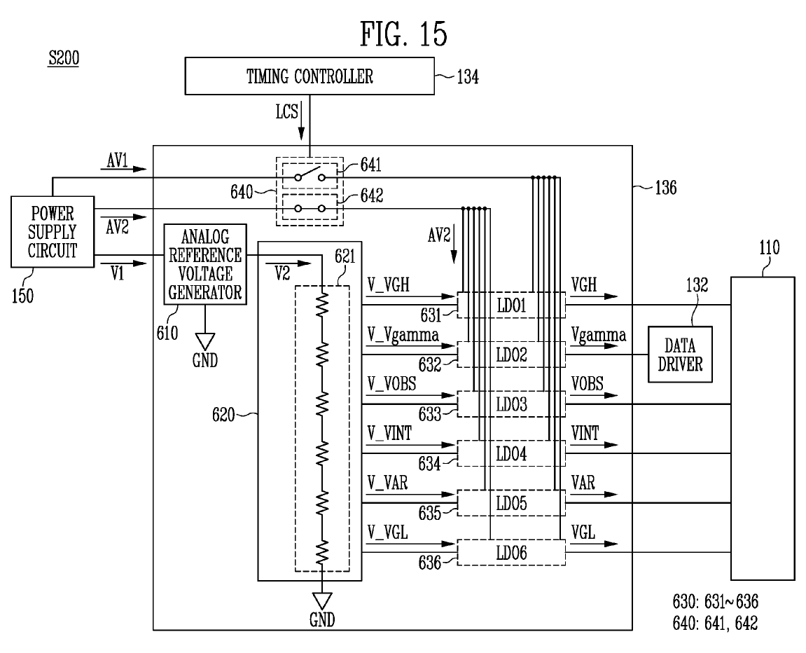

In step S200, during the active period AP, a process of controlling the second driving current AV2 to be supplied to the regulators 630 by supplying the switch control signal LCS to the power generator 136 may be performed. This process will be described below with reference to FIG. 15.

FIG. 14 is a diagram illustrating a driving operation in step S100 of FIG. 13.

Referring to FIGS. 13 and 14, the display device 100 may include the display panel 110, the data driver 132, the timing controller 134, the power generator 136, and the power supply circuit 150.

The power generator 136 may include the analog reference voltage generator 610, the voltage generation block 620, the regulators 630, and the switches 640.

The voltage generation block 620 may include the resistor string 621. The resistor string 621 may include a plurality of resistors connected in series. Referring to FIG. 6, the resistor string 621 may be connected between the analog reference voltage generator 610 and the ground power source GND.

The regulators 630 may include the first to sixth regulators 631 to 636. However, embodiments of the present disclosure are not necessarily limited thereto. For example, the number of regulators 630 may be more than six. For example, the number of regulators 630 may be six or less. Hereinafter, a description is made, assuming that there are six regulators 630 in the power generator 136.

The switches 640 may include the first and second switches 641 and 642.

The analog reference voltage generator 610 may receive the first voltage V1 from the power supply circuit 150, change (e.g., lower) the voltage level of the input voltage, and output a voltage of the changed voltage level (e.g., the second voltage V2 which is lower than the first voltage V1) to the voltage generation block 620.

The voltage generation block 620 may be configured to output two or more voltages using the second voltage V2. The voltage generation block 620 may generate and output two or more voltages from the second voltage V2 by using the resistor string 621. For example, the voltage generation block 620 may output at least one of the first input voltage V_VGH, the second input voltage V_Vgamma, the third input voltage V_VOBS, the fourth input voltage V_VINT, the fifth input voltage V_VAR, and the sixth input voltage V_VGL.

The voltage generation block 620 may output the first input voltage V_VGH to the first regulator 631. The voltage generation block 620 may output the second input voltage V_Vgamma to the second regulator 632. The voltage generation block 620 may output the third input voltage V_VOBS to the third regulator 633. The voltage generation block 620 may output the fourth input voltage V_VINT to the fourth regulator 634. The voltage generation block 620 may output the fifth input voltage V_VAR to the fifth regulator 635. The voltage generation block 620 may output the sixth input voltage V_VGL to the sixth regulator 636.

The first regulator 631 may generate the high-level voltage VGH based on the first input voltage V_VGH and may output the high-level voltage VGH to the display panel 110. The second regulator 632 may generate the gamma voltage Vgamma based on the second input voltage V_Vgamma and may output the gamma voltage Vgamma to the data driver 132. The third regulator 633 may generate the fourth power supply voltage VOBS based on the third input voltage V_VOBS and may output the fourth power supply voltage VOBS to the display panel 110. The fourth regulator 634 may generate the second power supply voltage VINT based on the fourth input voltage V_VINT and output the second power supply voltage VINT to the display panel 110. The fifth regulator 635 may generate the third power supply voltage VAR based on the fifth input voltage V_VAR and output the third power supply voltage VAR to the display panel 110. The sixth regulator 636 may generate the low-level voltage VGL based on the sixth input voltage V_VGL and output the low-level voltage VGL to the display panel 110.

The power supply circuit 150 may supply the first driving current AV1 and the second driving current AV2 to the power generator 136 (or the regulators 630) to drive the regulators 630.

The display panel 110 (see FIG. 1) may display an image on a frame-period basis. The display panel 110 may display an image during the active period AP (FIG. 11) of a frame period and may not display an image during the blank period BP (FIG. 11) of the frame period. In the blank period BP, in response to the switch control signal LCS, the first switch 641 may be turned on and the second switch 642 may be turned off. The regulators 630 may receive the first driving current AV1.

FIG. 15 is a diagram illustrating a driving operation in step S200 of FIG. 13.

Referring to FIGS. 13 and 15, the display device 100 may include the display panel 110, the data driver 132, the timing controller 134, the power generator 136, and the power supply circuit 150.

During the active period AP, in response to the switch control signal LCS, the first switch 641 may be turned off and the second switch 642 may be turned on. The regulators 630 may receive the second driving current AV2.

A display device according to an embodiment may be applied to a variety of electronic devices. An electronic device according to an embodiment includes the display device described above, and may further include a module or a device having other additional functions besides the display device.

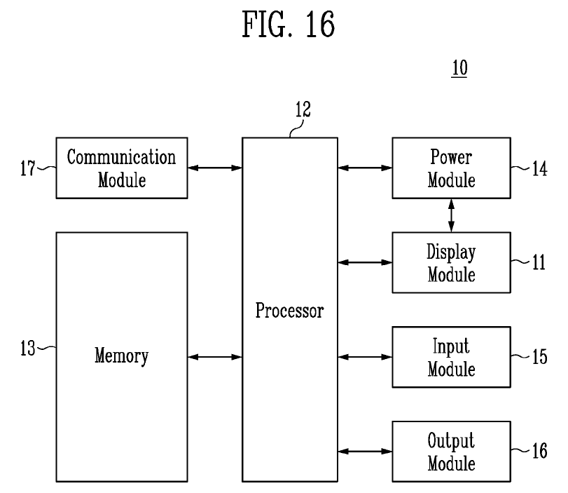

FIG. 16 is a block diagram of an electronic device 10 according to an embodiment. Referring to FIG. 16, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller. In an embodiment, the processor 12 may be divided into two or more parts from a functional or structural perspective. For example, the processor 12 includes a main processor in the form of a first driving chip including a CPU and an auxiliary processor in the form of a second driving chip. The auxiliary processor may include a controller that receives image signals from the main processor and processes the image signals to conform to interface specifications of the display module 11.

The memory 13 may include at least one of a non-volatile memory and a volatile memory. The memory 13 may store data and/or information used to operate the processor 12 or the display module 11. When the processor 12 executes an application stored in the memory 13, image data signals and/or input control signals may be transferred to the display module 11. The display module 11 may process the provided signals and display image corresponding to the provided signals on a display screen.

The power module 14 may include a power supply module, such as a power adapter or a battery device, and a power conversion module. The power conversion module converts power supplied by the power supply module and generates power to operate the electronic device 10. Power conversion performed by the power conversion module may include DC-DC conversion, AC-AC conversion, and DC-AC conversion, but embodiments are not limited thereto.

The electronic device 10 may further include an input module 15, a non-image output module 16, and/or a communication module 17.

The input module 15 may provide input information to the processor 12 and/or the display module 11. The input module 15 may include not only a physical button, a keyboard, and a microphone, but also various kinds of sensor modules. Examples of the sensor modules may include a biometric sensor, such as a blood pressure sensor, a blood glucose sensor, an electrocardiogram sensor, and a heart rate sensor, as well as a touch sensor, a pressure sensor, a distance sensor, a position sensor, a digitizer, a motion recognition sensor, a camera sensor (or an image sensor), a light receiving sensor, a photoelectric conversion sensor, and a temperature sensor.

The non-image output module 16 may receive information other than image information from the processor 12 and provide the information to a user. Examples of the non-image output module 16 may include an audio module, a haptic module, a light emitting module, and unique functional modules of the electronic device such as a cooling module of a refrigerator.

The communication module 17 may serve to facilitate information exchange between the electronic device 10 and an external device, and may include a transmitter and a receiver. The communication module 17 may include various types of wireless communication modules such as a mobile communication module, a WiFi module, and a Bluetooth module, or various kinds of wired communication modules.

At least one of the above-described components of the electronic device 10 may be included in the display device according to embodiments as described above. In addition, in terms of functionality, some of the individual modules included in one module may be included in the display device and others may be provided separately from the display device. For example, the display module 11 is included in the display device, whereas the processor 12, the memory 13, and the power module 14 are not included in the display device and are instead provided separately in the electronic device 10. However, the present disclosure is not limited thereto. For example, at least one of the processor 12, the memory 13, and the power module 14 may be included in the display device.

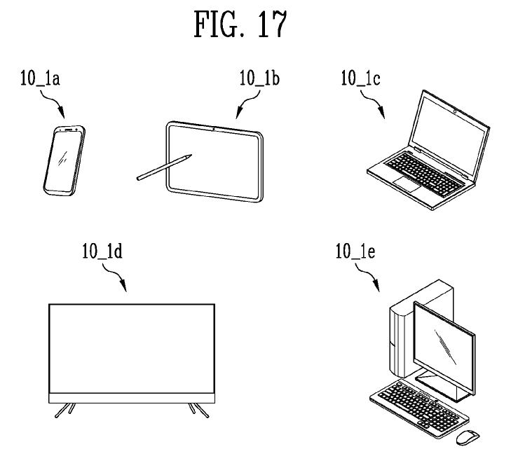

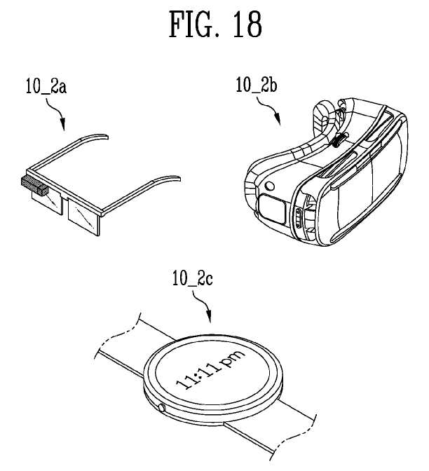

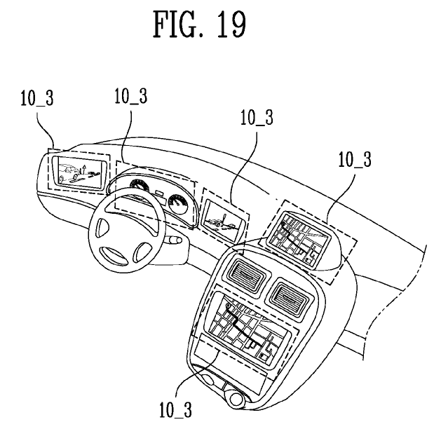

FIGS. 17 - 19 show schematic views of various embodiments of an electronic device. FIGS. 17 - 19 illustrate examples of various types of electronic devices to which embodiments of a display device are applied.

FIG. 17 shows a smartphone 10_1a, a tablet PC 10_1b, a laptop computer 10_1c, a television (TV) 10_1d, and a desktop monitor 10_1e as examples of the electronic device 10.

The smartphone 10_1a may include an input module, such as a touch sensor, and a communication module in addition to the display module 11. The smartphone 10_1a may process information received through the communication module or the input module and display the processed information on the display module of the display device.

Similarly to the smartphone 10_1a, each of the tablet PC 10_1b, the laptop computer 10_1c, the television (TV) 10_1d, and the desktop monitor 10_1e may include a display module and an input module, and further include a communication module.

FIG. 18 shows examples in which the electronic device 10 including the display module 11 is applied to a wearable electronic device. The examples of the wearable electronic device may include smart glasses 10_2a, a head-mounted display (HMD) 10_2b, and a smart watch 10_2c.

Each of the smart glasses 10_2a and the head-mounted display 10_2b may include a display module that projects a display image and a reflector that reflects the projected display image to direct it to the user’s eyes, thereby providing the user with a virtual reality or augmented reality screen.

The smart watch 10_2c may include a biometric sensor as an input device and provide biometric information detected by the biometric sensor to the user through a display module.

FIG. 19 shows an example in which the electronic device 10 including the display module 11 is applied to various kinds of an automotive electronic device 10_3. For example, the automotive electronic device 10_3 is applied to a center information display (CID), which may be employed in the instrument cluster or the center fascia of the vehicle or disposed at the dashboard of the vehicle. The automotive electronic device 10_3 may also be applied to a room mirror display replacing side mirrors.

Though not shown in FIG. 19, examples of electronic devices to which embodiments of a display device are applied may include various home appliances which display information on display modules, such as refrigerators, washing machines, dryers, air conditioners, and robot vacuum cleaners, as well as devices aimed at displaying images, such as billboards, electronic display boards, and game consoles. In addition, when a display module has a function of transmitting light, the display module may be applied to an electronic device such as a smart window or a transparent display device which displays a background and a display image together. However, the types of an electronic device according to an embodiment are not limited to the above-described examples, and other various types of electronic devices are applicable.

A display device and a method of driving a display device, and an electronic device including the display device according to embodiments of the present disclosure may reduce power consumption.

The effects of the embodiments are not limited by the above examples, and many more effects are included herein.

Although embodiments of the present disclosure have been explained with reference to the accompanying drawings above, it should be noted that those skilled in the art or those of ordinary skill in the art will understand that various modifications and changes can be made to the inventive concept within the scope that does not depart from the spirit and technical feature of the inventive concept set forth in the claims to be described later. Although specific terms are employed in describing the embodiments of the present disclosure, it will be understood that they are used and are to be interpreted in a generic and descriptive sense only and not for purpose of limitation. Accordingly, the technical scope of the inventive concept should not be limited to the content described in the detailed description of the specification, but should be determined by the claims described hereinafter.

What is claimed is:

1. A display device, comprising:
a display panel including sub-pixels;
a power generator including regulators configured to generate constant voltages and supply the constant voltages to the display panel;
a power supply circuit supplying the power generator with a first driving current and a second driving current for driving the regulators; and
a timing controller controlling the power generator to supply the first driving current to the regulators during a blank period within a frame period and supply the second driving current to the regulators during an active period within the frame period,
wherein the first driving current has a voltage greater than the second driving current.

2. The display device of claim 1, further comprising a data driver configured to supply data signal to the sub-pixels through data lines,
wherein each of the sub-pixels comprises a pixel circuit coupled to a corresponding data line,
wherein the data signal is written to the pixel circuit of each of the sub-pixels during the active period, and
wherein at least one transistor in the pixel circuit of each of the sub-pixels remains in a turn-off state during the blank period.

3. The display device of claim 1, wherein the timing controller outputs a switch control signal to the power generator to control the supply of the first driving current during the blank period and the supply of the second driving current during the active period.

4. The display device of claim 1, wherein each of the regulators comprises a first driving circuit and a second driving circuit, and
wherein the power generator comprises:
a first switch electrically connecting or disconnecting the power supply circuit and the first driving circuit of each of the regulators and; and
a second switch electrically connecting or disconnecting the power supply circuit and the second driving circuit of each of the regulators.

5. The display device of claim 4, wherein the first driving circuit comprises:
a first transistor including a first electrode connected to the first switch, a gate electrode connected to a first input terminal, and a second electrode connected to an output terminal; and
a second transistor including a first electrode connected to the second electrode of the first transistor, a gate electrode connected to a second input terminal, and a second electrode connected to a ground power source,
wherein the second driving circuit comprises:
a third transistor including a first electrode connected to the second switch, a gate electrode connected to the first input terminal, and a second electrode connected to the output terminal; and
a fourth transistor including a first electrode connected to the second electrode of the third transistor, a gate electrode connected to the second input terminal, and a second electrode connected to the ground power source, and
wherein the first driving circuit and the second driving circuit amplify a difference between voltages input to the first input terminal and the second input terminal, respectively, and output an amplified voltage difference to the output terminal.

6. The display device of claim 4, wherein the timing controller comprises a switch control section for controlling operations of the first switch and the second switch, and
wherein the switch control section turns on the first switch and turns off the second switch during the blank period, and turns off the first switch and turns on the second switch during the active period.

7. The display device of claim 4, wherein the timing controller comprises:
an amplifier receiving a data enable signal defining the active period and the blank period within the frame period, and amplifying the data enable signal; and
a comparator receiving an amplified data enable signal from the amplifier and comparing the amplified data enable signal with a reference value, and
wherein the comparator turns off the first switch and turns on the second switch when the amplified data enable signal is greater than the reference value, and
the comparator turns on the first switch and turns off the second switch when the amplified data enable signal is less than the reference value.

8. The display device of claim 4, wherein the timing controller comprises a counter counting a number of times a horizontal synchronization signal is received, the counter being reset upon receipt of a vertical synchronization signal, and
wherein the counter turns on the first switch and turns off the second switch until a predetermined number of the horizontal synchronization signals are received after receiving the vertical synchronization signal, and
the counter turns off the first switch and turns on the second switch from after receiving the predetermined number of the horizontal signals until the vertical synchronization signal is received again.

9. An electronic device, comprising:
a host transmitting control signals; and
a display device including a display panel on which sub-pixels are arranged,
wherein the display device further comprises:
a power generator including regulators configured to generate constant voltages and supply the constant voltages to the display panel;
a power supply circuit supplying the power generator with a first driving current and a second driving current for driving the regulators; and
a timing controller controlling the power generator based on the control signals,
wherein the timing controller controls the power generator to supply the first driving current to the regulators during a blank period within a frame period and supply the second driving current to the regulators during an active period within the frame period, and
wherein the first driving current has a voltage greater than the second driving current.

10. The electronic device of claim 9, wherein the display device further comprises a data driver configured to supply data signal to the sub-pixels through data lines,
wherein each of the sub-pixels comprises a pixel circuit coupled to a corresponding data line,
wherein the data signal is written to the pixel circuit of each of the sub-pixels during the active period, and
wherein at least one transistor in the pixel circuit of each of the sub-pixels remains in a turn-off state during the blank period.

11. The electronic device of claim 9, wherein the timing controller outputs a switch control signal to the power generator to control the supply of the first driving current during the blank period and the supply of the second driving current during the active period.

12. The electronic device of claim 9, wherein each of the regulators comprises a first driving circuit and a second driving circuit, and
wherein the power generator further comprises:
a first switch electrically connecting or disconnecting the first driving circuit and the power supply circuit of each of the regulators; and
a second switch electrically connecting or disconnecting the second driving circuit and the power supply circuit of each of the regulators.

13. The electronic device of claim 12, wherein the first driving circuit comprises:
a first transistor including a first electrode connected to the first switch, a gate electrode connected to a first input terminal, and a second electrode connected to an output terminal; and
a second transistor including a first electrode connected to the second electrode of the first transistor, a gate electrode connected to a second input terminal, and a second electrode connected to a ground power source,
wherein the second driving circuit comprises:
a third transistor including a first electrode connected to the second switch, a gate electrode connected to the first input terminal, and a second electrode connected to the output terminal; and
a fourth transistor including a first electrode connected to the second electrode of the third transistor, a gate electrode connected to the second input terminal, and a second electrode connected to the ground power source, and
wherein the first driving circuit and the second driving circuit amplify a difference between voltages input to the first input terminal and the second input terminal, respectively, and output an amplified voltage difference to the output terminal.

14. The electronic device of claim 12, wherein the timing controller comprises a switch control section for controlling operations of the first switch and the second switch, and
wherein the switch control section turns on the first switch and turns off the second switch during the blank period, and turns off the first switch and turns on the second switch during the active period.

15. The electronic device of claim 12, wherein the timing controller comprises:
an amplifier receiving a data enable signal defining the active period and the blank period within the frame period, and amplifying the data enable signal; and
a comparator receiving an amplified data enable signal from the amplifier and comparing the amplified data enable signal with a reference value, and
wherein the comparator turns off the first switch and turns on the second switch when the amplified data enable signal is greater than the reference value, and
the comparator turns on the first switch and turns off the second switch when the amplified data enable signal is less than the threshold value.

16. The electronic device of claim 12, wherein the timing controller comprises a counter counting a number of times a horizontal synchronization signal is received, the counter being reset upon receipt of a vertical synchronization signal, and
wherein the counter turns on the first switch and turns off the second switch until a predetermined number of the horizontal synchronization signals are received after receiving the vertical synchronization signal, and
the counter turns off the first switch and turns on the second switch from after receiving the predetermined number of the horizontal signals until the vertical synchronization signal is received again.

17. A method of driving a display device including a display panel on which sub-pixels are arranged, a power generator including regulators configured to generate constant voltages and supply the constant voltages to the display panel, and a power supply circuit supplying the power generator with a first driving current and a second driving current for driving the regulators, the method comprising:
supplying the first driving current to the regulators by supplying a switch control signal to the power generator during the blank period; and
supplying the second driving current to the regulators by supplying the switch control signal to the power generator during the active period,
wherein the first driving current has a voltage greater than the second driving current.

18. The method of claim 17, wherein each of the regulators comprises a first driving circuit and a second driving circuit, and the power generator further comprises a first switch electrically connecting or disconnecting the first driving circuit and the power supply circuit of each of the regulators and a second switch electrically connecting or disconnecting the second driving circuit and the power supply circuit of each of the regulators,
wherein the supplying the first driving current to the regulators comprises turning on the first switch and turning off the second switch during the blank period, and
wherein the supplying the second driving current to the regulators comprises turning off the first switch and turning on the second switch during the active period.

19. The method of claim 18, wherein the first driving circuit comprises:
a first transistor including a first electrode connected to the first switch, a gate electrode connected to a first input terminal, and a second electrode connected to an output terminal; and
a second transistor including a first electrode connected to the second electrode of the first transistor, a gate electrode connected to a second input terminal, and a second electrode connected to a ground power source,
wherein the second driving circuit comprises:
a third transistor including a first electrode connected to the second switch, a gate electrode connected to the first input terminal, and a second electrode connected to the output terminal; and
a fourth transistor including a first electrode connected to the second electrode of the third transistor, a gate electrode connected to the second input terminal, and a second electrode connected to the ground power source, and
wherein the first driving circuit and the second driving circuit amplify a difference between voltages input to the first
input terminal and the second input terminal, respectively, and output an amplified voltage difference to the output terminal.
